(19) United States
(12) Patent Application Publication
(10) Pub. No.: US 2007/0235062 A1
(43) Pub. Date: Oct. 11, 2007

(54) SUBSTRATE PROCESSING METHOD AND SUBSTRATE PROCESSING APPARATUS

(76) Inventors: Naozumi Fujiwara, Kyoto (JP); Katsuhiko Miya, Kyoto (JP); Akira Izumi, Kyoto (JP)

Correspondence Address: CHARLES N. DICKEY, 50 RICEVILLE ROAD C-207, ASHEVILLE, NC, 28805, US

(21) Appl. No.: 11/696,464

(22) Filed: Apr. 4, 2007

(30) Foreign Application Priority Data
Apr. 11, 2006 (JP) 2006-108801
Sep. 13, 2006 (JP) 2006-248181

(51) Int. Cl. B08B 7/00; B08B 3/00

(52) U.S. Cl. 134/4; 134/26

(57) ABSTRACT

A substrate on the surface of which the liquid film is formed in a cleaning unit is transported to a freezing unit by a substrate transporting mechanism. The liquid film is frozen in the freezing unit and the volume of the liquid film increases. Accordingly, adhesive forces between the substrate and the particles are reduced and the particles even come to separate from the substrate surface. Then the substrate which has been processed freezing is transported from the freezing unit to the cleaning unit again by the substrate transporting mechanism. In the cleaning unit, a physical and/or chemical cleaning is executed to the substrate, and the frozen film is removed from the substrate surface. Thus, the liquid film formation and the freezing of the liquid film is performed as a preprocessing of the physical and/or chemical cleaning in this way, whereby the particles are removed from the substrate surface efficiently.

### CROSS REFERENCE TO RELATED APPLICATION

The disclosure of Japanese Patent Applications No. 2006-108801 filed Apr. 11, 2006 and No. 2006-248181 filed Sep. 13, 2006 including specification, drawings and claims is incorporated herein by reference in its entirety.

### BACKGROUND OF THE INVENTION

1. Field of the Invention

The present invention relates to a substrate processing apparatus for and a substrate processing method of cleaning substrates of various types (hereinafter called simply “substrates”) such as semiconductor wafers, glass substrates for photomasks, glass substrates for liquid crystal displays, glass substrates for plasma displays and substrates for optical discs.

2. Description of the Related Art

Manufacturing steps for electronic components such as semiconductor devices and liquid crystal displays include a step of repeating film deposition, etching and otherwise appropriate processing on a surface of a substrate to thereby form fine patterns. As the surface of the substrate needs be kept clean for excellent microfabrication, the substrate is cleaned when needed. In the apparatus described in JP-A-8-318181 for instance, a processing liquid and gas are mixed, thereby generating droplets of the processing liquid, and the droplets are supplied to a surface of a substrate which needs be processed, whereby the substrate is cleaned. In short, upon supply of the droplets of the processing liquid to the surface of the substrate, the droplets collide with particles (contaminants) adhering to the surface of the substrate so that the particles are physically removed off from the surface of the substrate utilizing the kinetic energy of the droplets.

Meanwhile, for removal of particles adhering to a surface of a substrate, substrate cleaning which uses a chemical solution such as an SC1 solution (a liquid mixture of aqueous ammonia and a hydrogen peroxide solution) is exercised (JP-A-11-340185). In the apparatus described in JP-A-11-340185, a substrate is immersed inside a processing tank which is filled with an SC1 solution, thereby etching away a front layer of the substrate and particles adhering to the surface of the substrate. That is, utilizing the etching function of the SC1 solution, the particles adhering to the surface of the substrate are chemically removed.

### SUMMARY OF THE INVENTION

By the way, a device which is typically a semiconductor has increasingly finer patterns and more advanced functions and is more and more precise these days, which has lead to a new problem that defects occur in patterns formed on a surface of a substrate during cleaning of the substrate. That is, in the apparatus described in JP-A-8-318181, the condition of generating the liquid droplet is adjusted such that the kinetic energy of the liquid droplet is increased, whereby the rate of particles removed from the substrate surface (hereinafter called “removal rate”) is enhanced. However, a problem that the patterns are destroyed has occurred. On the other hand, when the condition of generating the liquid droplet is adjusted such that the defects do not occur in patterns, the particles cannot be removed enough.

Further, a device which needs have fine patterns, advanced functions and a high precision must be protected from excessive etching of a substrate surface, for the purpose of preventing device defects. However, where particles adhering to a substrate surface are to be removed with a desired removal efficiency using a chemical solution such as SC1 solution as in the apparatus described in JP-A-11-340185, it is necessary to etch the surface layer of the substrate comparatively thickly, which may lead to device defects. Accordingly, it is difficult to remove particles from the substrate surface efficiently without damaging the substrate.

The invention has been made in light of the problems described above, and accordingly, an object of the invention is to provide a substrate processing method and a substrate processing apparatus with which it is possible to remove particles adhering to a substrate surface without damaging the substrate.

According to a first aspect of the present invention, there is provided a substrate processing method of cleaning a substrate, the method comprising: a first step of freezing a liquid film as it is maintained adhering to a surface of the substrate; and a second step of performing upon the surface of the substrate physical cleaning which exerts a physical effect upon the surface of the substrate, chemical cleaning which exerts a chemical effect upon the surface of the substrate, or cleaning which combines the physical cleaning and the chemical cleaning, thereby removing the liquid film which has been processed freezing off from the surface of the substrate.

According to a second aspect of the present invention, there is provided a substrate processing apparatus for cleaning a substrate, the apparatus comprising: a freezing mechanism which freezes a liquid film as it is maintained adhering to a surface of the substrate; and a cleaning mechanism which performs, upon the surface of the substrate, physical cleaning which exerts a physical effect upon the surface of the substrate, chemical cleaning which exerts a chemical effect upon the surface of the substrate, or cleaning which combines the physical cleaning and the chemical cleaning, wherein the freezing mechanism freezes the liquid film adhering to the surface of the substrate as preprocessing prior to cleaning by the cleaning mechanism, and the cleaning mechanism performs upon the surface of the substrate the physical cleaning, the chemical cleaning or the cleaning which combines the physical cleaning and the chemical cleaning, thereby removing the liquid film which has been processed freezing off from the surface of the substrate.

The above and further objects and novel features of the invention will more fully appear from the following detailed description when the same is read in connection with the accompanying drawing. It is to be expressly understood, however, that the drawing is for purpose of illustration only and is not intended as a definition of the limits of the invention.

### BRIEF DESCRIPTION OF THE DRAWINGS

FIG. 1 is a graph which show the relationship between a particle removal rate and whether the preprocessing is performed or not before the cleaning with SC1 solution.

FIG. 2 is a graph which shows the relationship between a particle removal rate and whether the preprocessing is performed or not before the cleaning using two-fluid nozzle.

FIG. 3 is a graph which shows the relationship between a removal timing of a frozen film and a particle removal rate.

FIG. 4 is a plan layout diagram of a substrate processing apparatus of a first embodiment of this invention.

FIG. 5 is a block diagram showing a control construction of the substrate processing apparatus shown in FIG. 4.

FIG. 6 is a cross sectional view showing a construction of the cleaning unit equipped in the substrate processing apparatus shown in FIG. 4.

FIG. 7 is a diagram showing a construction of the freezing unit equipped in the substrate processing apparatus shown in FIG. 4.

FIG. 8 is a flow chart showing the operation of the substrate processing apparatus shown in FIG. 4.

FIG. 9 is a cross sectional view of the structure of a cleaning unit which is disposed in a substrate processing apparatus according to a second embodiment of the invention.

FIG. 10 is a drawing which shows the structure of a two-fluid nozzle which is disposed in the cleaning unit.

FIG. 11 is a diagram showing a substrate processing apparatus of a third embodiment of the invention.

FIG. 12 is a block diagram showing a control construction of the substrate processing apparatus shown in FIG. 11.

FIGS. 13A and 13B are diagrams showing an operation of the cooling gas discharge nozzle equipped in the substrate processing apparatus shown in FIG. 11.

FIG. 14 is a flow chart of the operation in the substrate processing apparatus shown in FIG. 11.

FIG. 15 is a diagram showing a modification of the substrate processing apparatus of the invention.

FIGS. 16A, 16B and 16C are drawings of a substrate processing apparatus according to a fourth embodiment of the invention.

FIGS. 17A and 17B are drawings of a substrate processing apparatus according to a fifth embodiment of the invention.

FIGS. 18A and 18B are drawings of a substrate processing apparatus according to a sixth embodiment of the invention.

FIG. 19 is a diagram showing a modification of the substrate processing apparatus of the invention.

FIG. 20 is a diagram showing a modification of a two-fluid nozzle.

FIG. 21 is a diagram showing a construction of a modification of a cleaning unit equipped in the substrate processing apparatus according to the invention.

FIG. 22 is a diagram showing a modification of a construction of a freezing unit equipped in the substrate processing apparatus according to the invention.

### DETAILED DESCRIPTION OF THE PREFERRED EMBODIMENTS

<Particle Removal Effect due to Physical and/or Chemical Cleaning after Freezing Liquid Film>

The inventors of this application verified through experiments the effect of removing particles by a physical and/or chemical cleaning after freezing liquid film. Describing in more specific details, the inventors compared and evaluated a rate of removing particles (hereinafter called simply “removal rate”) between the case where a physical and/or chemical cleaning is simply performed to a substrate surface and the case where a physical and/or chemical cleaning is performed after a liquid film adhering to a substrate surface is frozen. In this experiment, a cleaning using SC1 solution which is a liquid mixture of ammonia, hydrogen peroxide and water is performed as the chemical cleaning and a cleaning with a liquid droplets using a two-fluid nozzle is performed as the physical cleaning. The removal rate is compared between the case where a preprocessing of the liquid film formation and the liquid film freezing is performed and the case where the preprocessing is not performed for the physical cleaning and the chemical cleaning, respectively. Meanwhile, a bare Si substrate (no pattern is formed thereon at all) is selected as a typical example of a substrate for evaluation. The evaluation is executed in the case where the substrate surface is contaminated with Si dust whose particle diameters are 0.1 μm or larger as particles.

FIG. 1 is a graph which show the relationship between a particle removal rate and whether the preprocessing is performed or not before the cleaning with SC1 solution. At this stage, an outline of a processing steps in the case where the preprocessing is performed before the cleaning with SC1 solution (hereinafter called “SC1 cleaning”) is as follows. First, a liquid film is formed on the wafer surface (Step S1). Consequently, the liquid film formed on the substrate surface is frozen (Step S2). These Steps S1 and S2 correspond to the preprocessing before the SC1 cleaning. Then, SC1 solution is supplied to the wafer surface to defrost and remove the liquid film (frozen film) after freezing (Step S3A). Finally, a rinsing liquid is supplied to the wafer surface to perform rinsing and then the wafer is rotated in high speed to dry (spin drying) the wafer (Step S4). In FIG. 1, the data (the far-left bars in the graph) in the case where only the rinsing and the spin drying, that is, only the Step S4 is executed, and the data (the central bars in the graph) in the case where SC1 cleaning, and the rinsing and the spin drying (Steps S3A and S4) are executed, are shown as a comparison of the data (the far-right bars in the graph) in the case where the processing steps described above (Steps S1, S2, S3A and S4) are executed. Meanwhile, the evaluation is performed using two samples in order to improve the accuracy of the respective data of the experiment results. These evaluation procedures are described in detail hereinafter.

First, the procedure for evaluation of the removal rate in the case where the Steps S1, S2, S3A and S4 described above are executed will now be described. First, the wafer is put under forced contamination using a single-wafer-type substrate processing apparatus (Spin processor MP-2000 manufactured by Dainippon Screen Mfg. Co., Ltd.). To be more specific, while rotating the wafer, a dispersion liquid in which particles (Si dust) are dispersed is supplied to the wafer from a nozzle which is located facing the wafer. The amount of the dispersion liquid, the number of revolutions of the wafer and the processing time are appropriately adjusted so that approximately 8000 particles will adhere to the surface of the wafer. The number of the particles adhering to the surface of the wafer (initial count) is thereafter measured. Meanwhile, the number of the particles is measured using the inspection apparatus SP1 manufactured by KLA-Tencor company. The evaluation is performed in an area in which the edge of the wafer is cut, that is, the peripheral area of 10 mm from the outer circumference of the wafer is removed, using the rest of the wafer.

Next, pure water stored in a washed bottle, to be more specific, deionized water (hereinafter called “DIW”) is put on the wafer surface in a shape of a puddle to form a liquid film (water film) on the wafer surface (Step S1). Specifically, DIW in a washed bottle is supplied to the wafer surface. In such condition, the thickness of the liquid film is about 600 μm which is measured by comparing the wafer weight between before and after the liquid film formation.

The substrate is thereafter loaded into a freezer in which the liquid film is frozen for 3 hours (Step S2). Thus frozen substrate is loaded into the substrate processing apparatus (MP-2000). Thereafter, while rotating the wafer (revolution of the wafer being 500 rpm), SC1 solution is supplied (flow rate being 1.5 liters/min) and the wafer is cleaned for 30 seconds (Step S3A). Thus, the liquid film (frozen film) after freezing is defrosted and removed from the wafer surface. As the SC1 solution, a liquid mixture of NH₄OH (29 wt %)/H₂O₂ (30 wt %)/H₂O=1/1/50 in volume ratio is used at a room temperature. According to such condition of the SC1 solution (condition of concentration and temperature) and the processing time (30 seconds), the wafer is hardly etched. This is backed by the fact that, in the result of the experiment (FIG. 1), the particles on the wafer surface is hardly removed by only executing the SC1 cleaning and rinsing (Steps S3A and S4). That is, if the etching effect on the wafer is present, the particles would have been etched and removed with the surface layer of the wafer and a certain removal rate would have been obtained.

When the SC1 cleaning is completed, rinsing is performed to the wafer surface. To be more specific, while rotating the wafer (revolution of the wafer being 500 rpm), DIW is supplied (flow rate being 1.5 liters/min) as a rinsing liquid and the wafer is rinsed for 30 seconds. Consequently, the wafer is rotated in high speed to dry (spin drying) the wafer (Step S4).

Thus, the number of the particles adhering to the surface of the wafer subjected to a series of cleaning process is measured. The particle count after cleaning (after Steps S1, S2, S3A and S4 is executed) is compared with the initial (before cleaning) particle count already measured, and the removal rate is calculated.

On the other hand, with respect to the procedure for evaluation of the removal rate in the case where Steps S3A and S4 are executed, after the wafer is put under forced contamination, the SC1 cleaning, and rinsing and spin drying are executed without executing the liquid film formation process (Step S1) and the freezing process (Step S2). Furthermore, with respect to the procedure for evaluation of the removal rate in the case where only Step S4 is executed, after the wafer is put under forced contamination, only the rinsing and the spin drying are executed. Meanwhile, the processing condition for each Step is the same as that in the case where the Steps S1, S2, S3A and S4 described above are executed.

As clearly shown in FIG. 1, the particles are hardly removed only by executing rinsing and spin drying (Step S4) or by executing SC1 cleaning, rinsing and spin drying (Steps S3A and S4). On the other hand, in the case where the liquid film forming process (Step S1) and the freezing process (Step S2) are executed as the preprocessing before the SC1 cleaning, it turns out that the removal rate is dramatically higher. That is, it is found that the execution of the preprocessing before the SC1 cleaning assists the particle removal effect by means of the SC1 cleaning and improves the particle removal rate remarkably.

The mechanism of the improvement of the particle removal rate is explained as follows. Zeta potential (electrokinetic potential) of a surface of a solid in SC1 solution has a comparatively large value (negative value). Therefore, when SC1 solution is supplied to the wafer surface to fill in a gap between the wafer surface and the particles thereon with SC1 solution, a large repulsive force is applied between the wafer surface and the particles (hereinafter called “repulsion by SC1 solution”). When such repulsive force exceeds the adhesive force (attraction force) of the particles to the wafer surface, it is possible to remove the particles from the wafer surface. However, as shown by the result of the experiment when Steps S3A and S4 are executed, the repulsive force generated by SC1 solution is not large enough to exceed the attraction force only by supplying SC1 solution to the wafer surface.

On the other hand, a liquid film is formed on the wafer surface and the liquid film is frozen as a preprocessing before the SC1 cleaning, whereby the volume of the liquid film is increased, the adhesive forces between the wafer surface and the particles adhered to the surface thereof are reduced, and the particles even come to separate from the wafer surface. Thus, it is possible to reduce the attraction force between the wafer surface and the particles relatively compared to the case where the preprocessing is not executed. Furthermore, when the particles are made separated from the wafer surface in this way, SC1 solution gets into the gap between the wafer surface and the particles. As a result, the gap between the wafer surface and the particles is filled with SC1 solution, whereby the repulsion by SC1 solution is thoroughly effected. Furthermore, since the attraction force between the wafer surface and the particles is reduced, the repulsive force between the wafer surface and the particles exceeds the attraction force relatively. As a result, it is possible to remove the particles from the wafer surface efficiently. That is, the liquid film is frozen as the preprocessing before the SC1 cleaning, whereby the particle removal effect by SC1 solution is assisted, and the removal rate is improved remarkably.

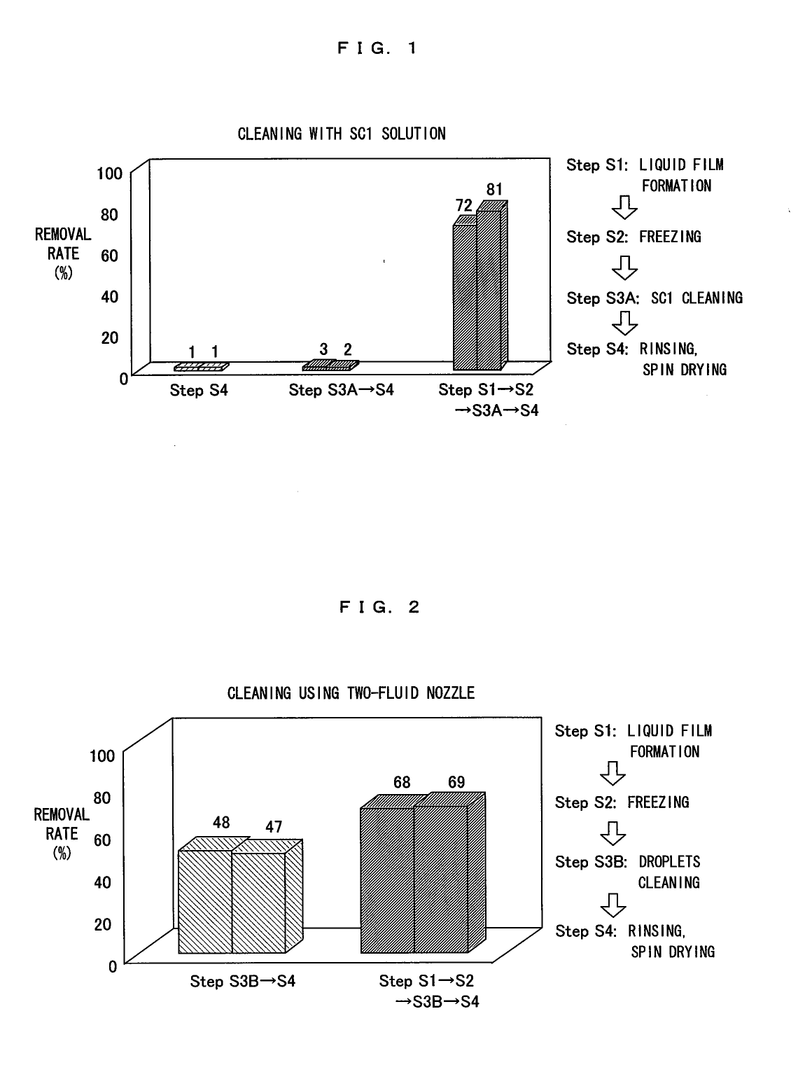

Next, an effect in the case where the preprocessing is executed before a cleaning with liquid droplets using a two-fluid nozzle is described with reference to FIG. 2. Here, as the physical and/or chemical cleaning, a cleaning with liquid droplets using a two-fluid nozzle (hereinafter called “droplets cleaning”) is executed instead of SC1 cleaning. The removal rate is compared between the case where the preprocessing of the liquid film formation and the liquid film freezing is performed and the case where the preprocessing is not performed before the droplets cleaning.

FIG. 2 is a graph which shows the relationship between a particle removal rate and whether the preprocessing is performed or not before the cleaning using two-fluid nozzle. In droplets cleaning, a so-called outside mixing type two-fluid nozzle is used which generates droplets by mixing a processing liquid with gas in air to supply toward the wafer surface. DIW is used as the processing liquid and nitrogen gas is used as the gas. Further, as the condition of generating droplets, the flow rate of DIW is 0.1 liter/min and the flow rate of nitrogen gas is 30 liters/min. And the droplets are supplied from the two-fluid nozzle to the entire wafer surface, while rotating the wafer (revolution of the wafer being 500 rpm). To be more specific, the two-fluid nozzle is positioned facing the wafer surface, and while discharging the droplets from the two-fluid nozzle, the two-fluid nozzle is moved above the wafer surface. In this way, the droplets cleaning of Step 3B is performed to the wafer surface. Meanwhile, other processing steps are basically the same as the processing steps shown in FIG. 1. However, the thickness of the liquid film is about 30 μm.

As clearly shown in FIG. 2, the removal rate is improved in the case where the preprocessing is executed (Steps S1, S2, S3B and S4) compared to the case where the preprocessing is not executed (Steps S3B and S4). That is, it turns out that the execution of the preprocessing before the droplets cleaning assists the particle removal effect by means of the droplets cleaning and improves the particle removal rate.

The mechanism of the improvement of the particle removal rate is explained as follows. In the droplets cleaning, utilizing the kinetic energy of the droplets, the droplets collide with the particles adhering to the wafer surface to remove the particles from the wafer surface. At this stage, as the adhesion forces of the particles to the wafer surface increase, the energy (kinetic energy) necessary to separate the particles from the wafer surface increases. Consequently, a liquid film (water film) is formed on the wafer surface and the liquid film is frozen as a preprocessing before the droplets cleaning, whereby the adhesive forces of the particles to the wafer surface are reduced in advance, and the particles even come to separate from the wafer surface into the frozen film. Thus, it is possible to reduce the attraction force between the wafer surface and the particles relatively compared to the case where the preprocessing is not executed. Therefore, the particle removal effect by the droplets cleaning is assisted by executing the preprocessing and the removal rate is improved, even when the kinetic energy of the droplets is the same.

On the other hand, it is possible to adjust the condition of generating the liquid droplet such that the kinetic energy of the liquid droplet is increased, and accordingly to enhance the separation of the particles from the wafer surface by the collision of the particles and the droplets. However, when the kinetic energy of the liquid droplet is increased in order to give the particles enough energy to separate from the wafer surface, the fine patterns formed on the wafer surface are also destroyed. Compared with this, the liquid film adhering to the wafer surface is frozen as a preprocessing before the droplets cleaning, whereby the adhesive forces of the particles to the substrate surface are decreased. Thus, even the droplets having comparatively small kinetic energy can easily remove the particles from the substrate surface. Therefore, the removal rate can be improved without damaging the substrate.

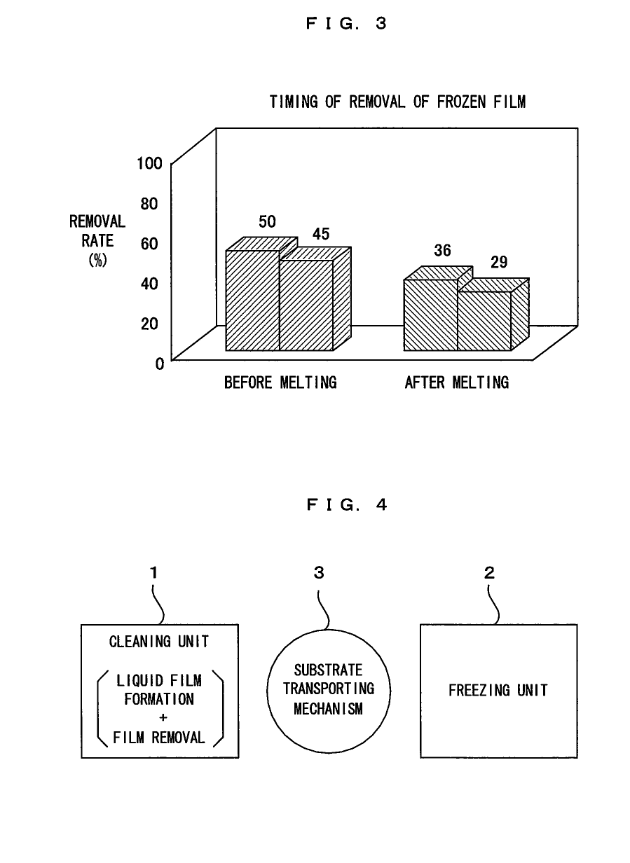

Next, the effect on the removal rate of the difference of the timing to remove the frozen film is described with reference to FIG. 3. Here, the liquid film (water film) adhered to the wafer surface is frozen. Then, the evaluation is made whether the removal rate is different or not between the case where the frozen film (ice film) is removed in a frozen state by cleaning and the case where the frozen film is cleaned and removed after completely melted.

FIG. 3 is a graph which shows the relationship between a removal timing of a frozen film and a particle removal rate. Here, after a liquid film adhered to the wafer surface is frozen, cleaning and rinsing is executed with DIW and then the wafer is rotated in high speed to dry (spin drying). At this stage, as the processing conditions in cleaning and rinsing with DIW, the flow rate is 1.5 liter/min, the revolution number of the wafer is 500 rpm, and the processing time is 30 seconds. This cleaning with DIW is executed before the frozen film is melted as for one sample (shown on the left-hand side in the graph), and the cleaning with DIW is executed after the frozen film is completely melted as for the other sample (shown on the right-hand side in the graph).

As clearly shown in FIG. 3, the removal rate is higher in the case where the frozen film (ice film) is removed by the cleaning in a frosted state compared to the case where the frozen film is removed by the cleaning after completely melted. Such a result can be explained as follows. That is, although the adhesion forces of the particles to the wafer surface are reduced and the particles are separated therefrom by freezing the liquid film, as the frozen film melts, the adhesion forces increase and the particles adhere to the wafer surface again. Consequently, the frozen film is removed from the substrate surface before melting, whereby the particles having been separated from the wafer are prevented from adhering to the wafer again. As a result, it is possible to remove the particles from the wafer surface efficiently.

Next, the effect on the removal rate of the difference of the cleaning condition is described with reference to Table. 1. Here, the substrate surface is cleaned with DIW after the liquid film adhered to the wafer surface is frozen. And in cleaning the substrate surface, the effect on the removal rate is measured when the revolution number of the wafer and the flow rate of DIW which is supplied to the substrate surface are varied.

TABLE 1
RELATIONSHIP BETWEEN CLEANING CONDITIONS
(REVOLUTION NUMBER, FLOW RATE) AND
REMOVAL RATE

| | | FLOW RATE OF DIW (L/min) | | |
|---|---|---|---|---|
| | | L/min | | |
| | rpm | 0.3 | 1.5 | 2.4 |
| WAFER | 50 | 26 (%) | 41 (%) | (50) (%) |
| REVOLUTION | 500 | 46 (%) | 42 (%) | 56 (%) |
| NUMBER | 1000 | 40 (%) | 49 (%) | (50) (%) |
| (rpm) | 1500 | 52 (%) | 46 (%) | (50) (%) |

Table 1 shows the relationship between a cleaning condition and a particle removal rate. To be more specific, the particle removal rate is measured at 50, 500, 1000, 1500 rpm as the revolution number of the wafer, and at 0.3, 1.5, 2.4 liter/min as the flow rate of DIW. As clearly shown in Table 1, there is little difference in the removal rate depending upon the difference of the cleaning condition, except in the case where the revolution number of the wafer is comparatively low (50 rpm) and where the flow rate of DIW is comparatively low (0.3 liter/min). Further, in the case where the flow rate of DIW is not less than 1.5 liter/min, the removal rate is approximately constant regardless of the revolution number of the wafer. Thus, it turns out that a certain removal rate is obtained regardless of the revolution number of the wafer, when a predetermined flow rate of DIW supplied to the wafer surface is ensured.

Noting the above, before the cleaning is executed, a preprocessing of liquid film formation and freezing the liquid film is executed, the cleaning being a physical cleaning which has a physical action to a substrate surface such as droplets cleaning, a chemical cleaning which has a chemical action to a substrate surface such as SC1 cleaning, or a cleaning of a combination of the physical cleaning and the chemical cleaning. And hence, the removal rate of the particles adhering to the substrate surface. Specific embodiments will now be described with reference to the associated drawings.

### First Embodiment

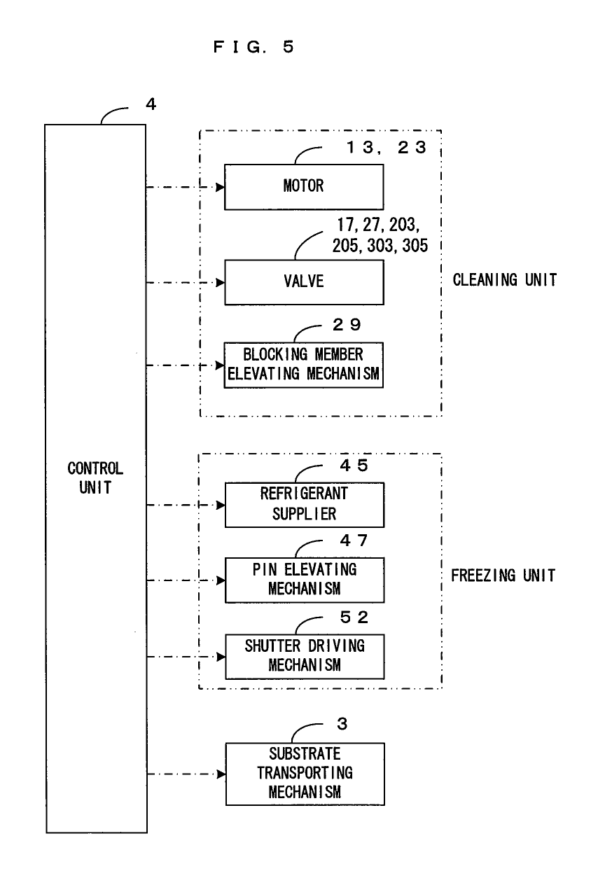

FIG. 4 is a plan layout diagram of a substrate processing apparatus of a first embodiment of this invention. FIG. 5 is a block diagram showing a control construction of the substrate processing apparatus shown in FIG. 4. In this substrate processing apparatus, a cleaning unit 1 and a freezing unit 2 are arranged while being separated from each other by a specified distance, and a substrate transporting mechanism 3 is arranged between the units 1 and 2. Out of these units, the cleaning unit 1 is a unit which forms a liquid film on a surface of each substrate such as a semiconductor wafer and removes the liquid film after the freezing. The substrate having the liquid film formed on the surface thereof in the cleaning unit 1 is transferred to the freezing unit 2 by the substrate transporting mechanism 3. In the freezing unit 2, a frozen film is formed by freezing the liquid film by applying a freezing process to the substrates. The substrate subjected to the freezing process is transported by the substrate transporting mechanism 3 to the cleaning unit 1, in which the frozen film is removed from the substrate surface. Thus, the cleaning unit 1 functions as a “cleaning mechanism” of the invention and the freezing unit 2 functions as a “freezing mechanism” of the invention. It should be noted that the construction and operation of the substrate transporting mechanism 3 are not described here since a conventionally frequently used mechanism is employed as such.

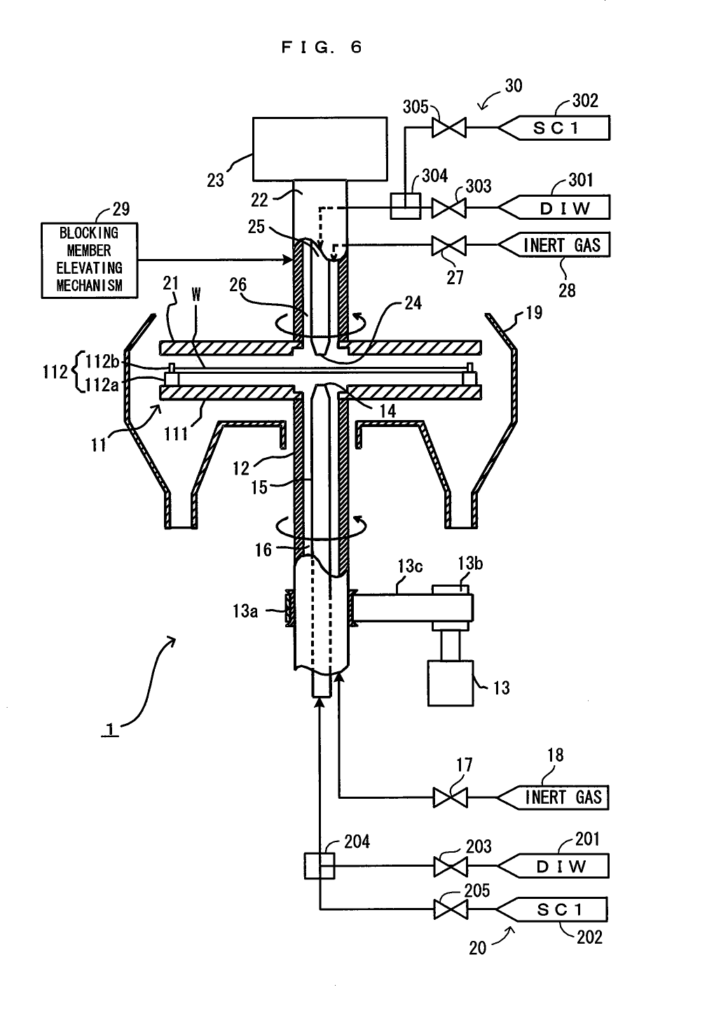

FIG. 6 is a cross sectional view showing a construction of the cleaning unit equipped in the substrate processing apparatus shown in FIG. 4. This cleaning unit 1 includes a spin chuck 11 which holds the substrate W approximately horizontally in a state that the surface of the substrate W facing above. The cleaning unit 1 can form the liquid film by supplying a processing liquid to the substrate surface while rotating the substrate W and can remove the frozen film by supplying the processing liquid to the both surfaces of the substrate W.

The spin chuck 11 includes a disc-shaped base member 111 that also functions as a blocking member at the underside of the substrate W, and three or more holders 112 arranged on the upper surface of the base member 111. Each of these holders 111 includes a supporting portion 112a which supports the outer peripheral end of the substrate W from below and a restricting portion 112b which restricts the position of the outer peripheral edge of the substrate W. The holders 111 are arranged near the outer peripheral end of the base member 111. The respective restricting portions 112b are constructed to take such an operative state as to hold the substrate W by being kept in contact with the outer peripheral edge of the substrate W and such an inoperative state as to free the substrate W by being moved away from the outer peripheral edge of the substrate W. In the inoperative state, the restricting portions 112b enable the substrate W to be loaded onto and unloaded from the supporting portions 112a by the substrate transporting mechanism 3. On the other hand, by switching the respective restricting portions 112b to the operative state after the substrate W is placed on the supporting portions 112a with the surface (pattern forming surface) of the substrate W faced up, whereby the substrate W is held by the spin chuck 11.

Further, the upper end of a hollow rotary shaft 12 is mounted to the lower surface of the base member 111. A pulley 13a is firmly fixed to the bottom end of this rotary shaft 12, and a torque of a motor 13 is transmitted to the rotary shaft 12 via a belt 13c spanning between this pulley 13a and a pulley 13b firmly fixed to the rotary shaft of the motor 13. Thus, the substrate W held by the spin chuck 11 is rotated about the center thereof by driving the motor 13. In this embodiment, the motor 13 thus corresponds to a “rotator” of the invention.

A nozzle 14 is fixedly disposed in the center of the base member 111. A processing liquid supply pipe 15 is inserted into the hollow rotary shaft 12, and the nozzle 14 is coupled to the upper end thereof. The processing liquid supply pipe 15 is connected to a liquid supplier 20 which supplies a processing liquid. The processing liquid can be discharged from the nozzle 14 by being supplied from the liquid supplier 20. The construction of the liquid supplier 20 will be described in detail hereinafter.

Further, a clearance between the inner wall surface of the rotary shaft 12 and the outer wall surface of the processing liquid supply pipe 15 forms a cylindrical gas supply passage 16. This gas supply passage 16 is connected to a gas supplier 18 via a valve 17, so that nitrogen gas can be supplied to a space between the base member 111 as a blocking member and the underside of the substrate W. Although nitrogen gas is supplied from the gas supplier in this embodiment, air or another inert gas may be discharged.

A blocking member 21 is disposed above the spin chuck 11. This blocking member 21 is mounted to the bottom end of a vertically arranged suspension arm 22. A motor 23 is disposed at the upper end of this suspension arm 22, so that the blocking member 21 is rotated about the suspension arm 22 by driving the motor 23. It should be noted that the center of rotation of the rotary shaft 72 of the spin chuck 11 and that of the suspension arm 22 are aligned, so that the base member 111, the substrate W held by the spin chuck 11 and the blocking member 21 are concentrically rotated. Further, the motor 23 is constructed to rotate the blocking member 21 in the same direction and substantially at the same rotating speed as (the substrate W held by) the spin chuck 11.

Further, the blocking member 21 is connected to a blocking-member elevating mechanism 29, so that the blocking member 21 can be moved toward the base member 111 to face the base member 111, and conversely, away therefrom by actuating the blocking-member elevating mechanism 29 in accordance with an operation command from a control unit 4. Specifically, the control unit 4 causes the blocking member 21 to move upward to a retracted position above the spin chuck 11 upon loading and unloading the substrate W into and from the substrate processing apparatus by actuating the blocking-member elevating mechanism 29. On the other hand, the control unit 4 causes the blocking member 21 to move downward to a specified facing position (position shown in FIG. 6) set very close to the surface of the substrate W held by the spin chuck 11 upon cleaning the substrate at a substrate processing position (height position of the substrate W held by the holders 112) where the substrate W is distanced upward from the base member 111 by a specified distance.

A nozzle 24 is disposed in the center of the blocking member 21. A processing liquid supply pipe 25 is inserted into the hollow suspension arm 22, and the nozzle 24 is coupled to the bottom end thereof. The processing liquid supply pipe 25 is connected to a liquid supplier 30 which supplies a processing liquid. The processing liquid can be discharged from the nozzle 24 by being supplied from the liquid supplier 30. The construction of the liquid supplier 30 will be described in detail hereinafter.

A clearance between the inner wall surface of the suspension arm 22 and the outer wall surface of the processing liquid supply pipe 25 forms a cylindrical gas supply passage 26. This gas supply passage 26 is connected to a gas supplier 28 via a valve 27, so that nitrogen gas can be supplied to a space formed between the blocking member 21 and the upper surface (surface) of the substrate W.

Further, a cup 19 which prevents the processing liquid from splashing to the surrounding area is arranged around the spin chuck 11. The processing liquid collected by the cup 19 is discharged to the outside of the apparatus to be stored in a tank (not shown) disposed below the cup 19.

Next, constructions of the liquid suppliers 20 and 30 are described. The liquid supplier 20 includes a DIW supplier 201 which supplies DIW and a chemical solution supplier 202 which supplies SC1 solution. The DIW supplier 201 is connected to a mixing unit 204 via a valve 203, whereas the chemical solution supplier 202 is connected to the mixing unit 204 via a valve 205. As the SC1 solution, a liquid mixture of NH₄OH (29 wt %)/H₂O₂ (30 wt %)/H₂O=1/1/50 in volume ratio is used at a room temperature.

And, DIW or the SC1 solution can be selectively supplied to a backside surface of the substrate W from the mixing unit 204 by the switch of the opening and closing of the valves 203 and 205 in accordance with a control command from the control unit 4 which controls the entire apparatus. That is, the valve 203 is opened and the valve 205 is closed, whereby DIW is supplied from the nozzle 14 to the backside surface of the substrate W, whereas the valve 203 is closed and the valve 205 is opened, whereby SC1 solution is supplied from the nozzle 14 to the backside surface of the substrate W. Meanwhile, in the case where a plurality of chemical solutions are used, a chemical supplier having the same structure may be provided for each chemical solution.

Further, the liquid supplier 30 has the same construction as the liquid supplier 20, and DIW or the SC1 solution can be selectively supplied to a front surface of the substrate W from a mixing unit 304 by the switch of the opening and closing of valves 303 and 305 in accordance with a control command from the control unit 4 which controls the entire apparatus. In this embodiment, the liquid supplier 30 which supplies SC1 solution to the front surface of the substrate W thus functions as a “supplier” of the invention.

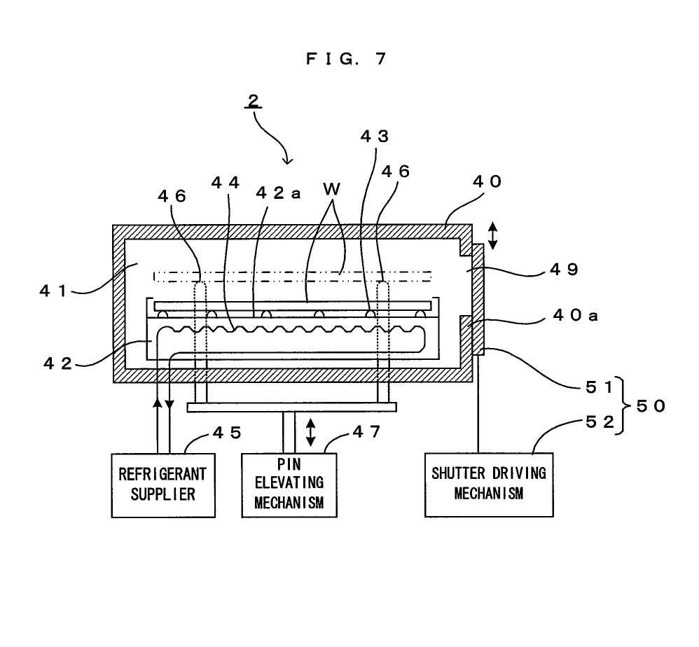

Next, the freezing unit 2 is described with reference to FIG. 7. FIG. 7 is a diagram showing a construction of the freezing unit 2 equipped in the substrate processing apparatus shown in FIG. 4. This freezing unit 2 performs a freezing process for freezing the liquid film formed on the substrate surface. The freezing unit 2 includes a cooling plate (substrate cooling section) 42 made of quartz, SUS, or aluminum having a size equal to or slightly larger than the substrate in plan view in a processing chamber (cooling chamber) 41 substantially in the form of a rectangular parallelepiped defined by a partition wall 40. This cooling plate 42 includes a substrate cooling surface 42a which is arranged to be substantially horizontal and has a size larger than the substrate in plan view. A plurality of spherical proximity balls (supporters) 43 project from the substrate cooling surface 42a. A refrigerant path 44 is formed substantially in parallel with the substrate cooling surface 42a inside the cooling plate 42, and the opposite ends thereof are connected to a refrigerant supplier 45. The refrigerant supplier 45 includes a cooling section which cools refrigerant and a pumping section such as a pump which pressure-feeds the refrigerant to the refrigerant path 44 to circulate it in the refrigerant path 44. Thus, the refrigerant is supplied from the refrigerant supplier 45 and the one having come out of the refrigerant path 44 is returned to the refrigerant supplier 45 again. Any refrigerant may be used provided that it can cool the substrate cooling surface 42a below the freezing point of liquid forming the liquid film.

A plurality of lift pins 46 are arranged to vertically penetrate the cooling plate 42, and an approaching/receding mechanism which brings the substrates W toward and away from the substrate cooling surface 42a are constructed by the lift pins 46 and a pin elevating mechanism 47 including an air cylinder which moves the lift pins 46 upward and downward. The lift pins 46 can support the substrate W on the upper ends thereof. The lift pins 46 can support the substrate W at a substrate transferring height (position shown in chain double-dashed line) where the substrate W is transferred to and from the substrate transporting mechanism 3 by being moved upward by the pin elevating mechanism 47 and, in addition, can place the substrate W on the substrate cooling surface 42a (on the proximity balls 43 to be precise, position shown in solid line) by being retracted until the upper ends thereof are located below the substrate cooling surface 42a of the cooling plate 42 (below the proximity balls 43 to be precise).

In a front partition wall 40a the substrate transporting mechanism 3 can face, a substrate transit port 49 is formed at a position corresponding to the substrate transferring height and a shutter mechanism 50 is provided for opening and closing the substrate transit port 49. This shutter mechanism 50 includes a shutter plate 51 which can close the substrate transit port 49 and a shutter driving mechanism 52 which moves the shutter plate 51 between a closing position at which the substrate transit port 49 is closed and a opening position at which the substrate transit port 49 is opened. In a state that the shutter plate is positioned at the opening position to open the substrate transit port 49, the substrate transporting mechanism 3 enters the processing chamber 41 to transfer the substrate W with the lift pins 46. The respective operations of the refrigerant supplier 45, the pin elevating mechanism 47 and the shutter driving mechanism 52 are controlled by the control unit 4.

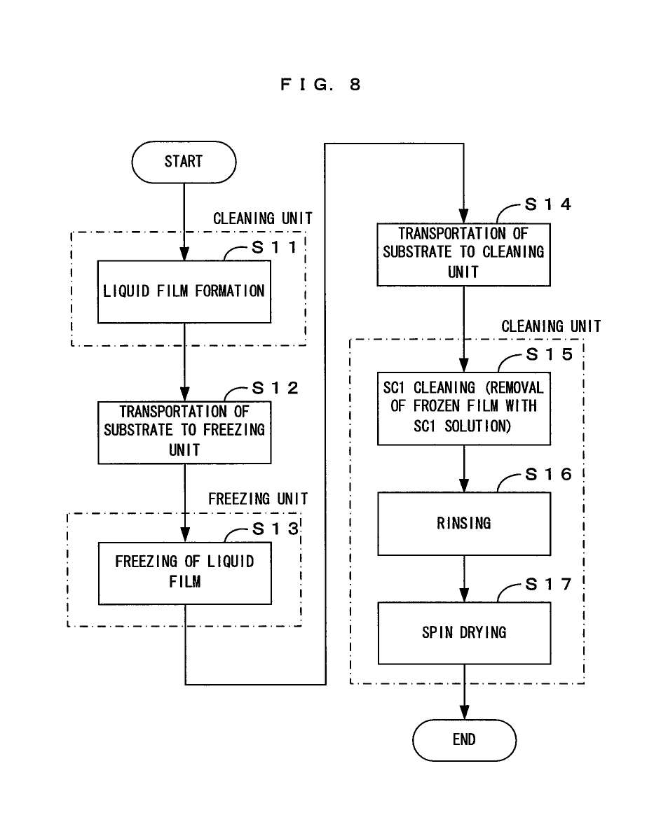

Next, an operation of the substrate processing apparatus constructed as above is described in detail with reference to FIG. 8. FIG. 8 is a flow chart showing the operation of the substrate processing apparatus shown in FIG. 4. An operation of the individual parts of the apparatus is described here focusing one substrate W in order to assist in understanding the operation. The substrate W subjected to a specified processing (chemical processing for instance) in the previous process is transported to the cleaning unit 1 and held by the spin chuck 11. And the control unit 4 drives the motor 13 to rotate the spin chuck 11 and opens the valve 303 to supply DIW to the surface of the substrate W from the nozzle 24. The DIW supplied to the substrate surface is evenly spread over the entire surface by the action of a centrifugal force resulting from the rotation of the substrate W, and part thereof is sputtered from the substrate W. As a result, the substrate surface is cleaned with water and a liquid film (water film) having a specified thickness is formed on the substrate surface (Step S11).

When the formation of the liquid film is completed in this way in the cleaning unit 1, the substrate W is transported from the cleaning unit 1 to the freezing unit 2 by the substrate transporting mechanism 3 inside the apparatus before the liquid film formed on the substrate surface dries (Step S12). Specifically, after being unloaded from the cleaning unit 1 by the substrate transporting mechanism 3, the substrate W is loaded into the processing chamber 41 of the freezing unit 2 and placed on the lift pins 46. The control unit 4 controls a transportation time such that this transportation of the substrates W is completed within a specified time limit. By transporting the substrates W in this way, the drying of the liquid film can be suppressed and the thickness of the liquid film remaining on the substrate surfaces can be precisely controlled. It should be noted that the shutter plate 51 is moved upward to open the substrate transit port 49 and the lift pins 46 are moved upward.

Then, the control unit 4 moves the shutter plate 51 to close the port 49 and controls the pin elevating mechanism 47 to move the lift pins 46 downward. The substrate W is brought closer to the substrate cooling surface 42a to be placed on the proximity balls 43. In this way, the underside of the substrate W comes into contact with the proximity balls 43 to be supported, and is arranged in proximity to the substrate cooling surface 42a while facing the substrate cooling surface 42a with a small clearance defined between this underside and the substrate cooling surface 42a. Accordingly, the substrate W is cooled from the underside thereof by the thermal conduction of cold from the substrate cooling surface 42a while being supported proximate to the substrate cooling surface 42a by the proximity balls 43. As a result, a liquid film adhering to the substrate surface freezes (Step S13: first step).

At this time, the particles adhering to the substrates W move only marginal distances due to the volume expansion of the liquid film (when water of 0° C. becomes ice of 0° C., the volume thereof increases by about 1.1 times). Specifically, the particles are moved away from the substrate surfaces by marginal distance since the liquid film having entered between the substrate surface and the particles increase in volume. As a result, adhesive forces between the substrate W and the particles are reduced and the particles even come to separate from the substrate surface. At this time, even in the case where fine patterns are formed on the substrate surface, the pressure applied to the patterns by the volume expansion of the liquid film is equal in all directions, that is, the forces applied to the patterns cancel each other, and hence, the patterns are not destroyed. Furthermore, although the liquid (DIW) has entered spaces between the particles and the substrates W, the device patterns formed on the substrate surfaces integrally adhere to the substrates and, hence, the liquid does not enter spaces between these patterns and substrate bases. Therefore, only the particles can be selectively and preferentially removed from the substrate surfaces without peeling or destroying the patterns.

When the freezing of the liquid films is completed after the lapse of a specified period, the control unit 4 controls the pin elevating mechanism 47 to move the lift pins 46 upward to guide the substrate W to the substrate transferring height. Then, the shutter plate 51 is opened and the freezing-processed substrate W is transferred to the substrate transporting mechanism 3 through the substrate transit port 49. Thereafter, the substrate W subjected to the freezing process is unloaded from the freezing unit 2 by the substrate transporting mechanism 3 and transported to the cleaning unit 1 again (Step S14). Here, the substrate W may be transported at any arbitrary timing from the freezing unit 2 to the cleaning unit 1 unless being left unattended. In other words, the substrate W may be transported after the frozen film melt or the transportation of the substrate W may be completed before the frozen films melt. However, by transporting the substrate W before the frozen films completely melt as in the latter case, the readhesion of the contaminants having separated from the substrate W once by the freezing process to the substrate W can be securely avoided. Accordingly, the control unit 4 preferably controls the transportation time such that the substrate transporting mechanism 3 completes the transportation of the substrate W before the frozen film melts.

When the substrate W subjected to the freezing process is loaded into the cleaning unit 1, the substrate W is held by the spin chuck 11. Thereafter, the blocking member 21 is positioned proximity to the substrate surface (upper surface). And, with the substrate W held between the base member 111 and the blocking member 21, the control unit 4 starts driving the motor 13 to rotate the substrate W with the spin chuck 11. Further, the valves 205 and 305 are opened to pressure-feeds SC1 solution to the nozzles 14 and 24 as a processing liquid. Thus, the supply of SC1 solution to the both sides of the substrate W from the nozzles 14 and 24 is started and the cleaning with SC1 solution (SC1 cleaning) is executed.

Thus, the frozen film on the substrate surface is defrosted and removed from the substrate surface by the SC1 solution (Step S15; second step). That is, the particles in the liquid film which adhesive forces to the substrate W are reduced or the particles in the liquid film which has separated from the substrate surface by the freezing of the liquid film are removed from the substrate surface and spread in the SC1 solution. Further, the particles dispersed in the SC1 solution are easily discharged outside the substrate with the SC1 solution by the action of a centrifugal force resulting from the rotation of the substrate W. That is, the particles are washed away toward outside the substrate by the SC1 solution supplied to the substrate surface, and the flow rate of the particles is increased by the centrifugal force, and the discharge of the particles from the substrate W is enhanced. Therefore, it is possible to remove the particles from the substrate W without damaging the patterns formed on the substrate surface. Further, as for the backside surface (under surface) of the substrate W also, the SC1 solution spreads the entire backside surface by the rotation of the substrate W, whereby the backside surface of the substrate W is cleaned. Hence, it is possible to remove the particles not only from the front surface of the substrate but the entire substrate W.

When the completion of the film removing process in Step S15 is confirmed, the valves 205 and 305 are closed to stop the supply of the SC1 solution to the substrate W from the nozzles 14 and 24. The rotation of the substrate W is continued thereafter to throw away and discharge the SC1 solution outside the apparatus. The throwing away of the SC1 solution is completed in this way, the valves 17 and 27 are opened to supply the inert gas to a space between the substrate W and the base member 111 and to a space between the substrate W and the blocking member 21. After the surrounding atmosphere of the substrate W is changed to inert gas atmosphere, the valves 203 and 303 are opened to supply the DIW as rinsing liquid to both principal surfaces of the substrate W, whereby rinsing is performed to the substrate W (Step S16). After the rinsing, the valves 203 and 303 are closed.

Subsequently, the control unit 4 causes the substrate W and the blocking member 21 to rotate at high speed by increasing the rotating speeds of the motors 13 and 23. In this way, the substrate W is dried (spin-dried) (Step S17). After completing the drying of the substrate W, the rotations of the substrate W and the blocking member 21 are stopped and the valves 17 and 27 are closed to stop the supply of the inert gas. In this state, the substrate transporting mechanism 3 unloads the processed substrate W from the apparatus to end a cleaning process to one substrate W.

As described above, according to this embodiment, a liquid film (water film) is adhered to a substrate surface and the liquid film is frozen as a preprocessing before the SC1 cleaning. With this, the adhesive forces of the particles to the substrate surface are reduced, and the particles even come to separate from the substrate surface into the liquid film which has been processed freezing. Thus, it is possible to reduce the attraction force between the substrate surface and the particles relatively compared to the case where the preprocessing is not executed. Further, when the particles are made separated from the substrate surface in this way, in a process of supplying SC1 solution to the substrate surface and cleaning, SC1 solution gets into the gap between the wafer surface and the particles easily. Therefore, the repulsion by SC1 solution is thoroughly effected. Furthermore, since the attraction force between the substrate surface and the particles is reduced, the repulsive force between the substrate surface and the particles exceeds the attraction force relatively. As a result, it is possible to remove the particles from the substrate surface efficiently. That is, the liquid film is frozen as the preprocessing before the SC1 cleaning, whereby the particle removal effect by SC1 solution is assisted. As a result, the removal rate is improved remarkably without damaging the substrate W compared to the case where only the chemical cleaning such as SC1 cleaning is executed to the substrate W.

### Second Embodiment

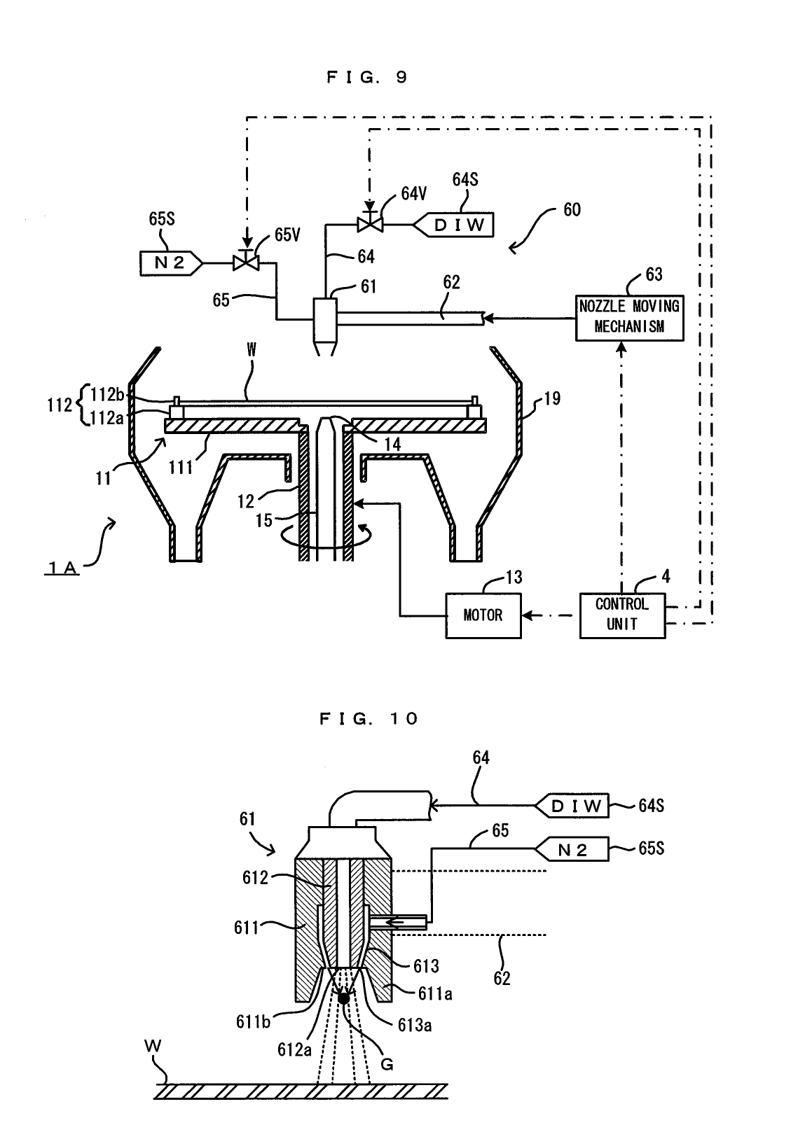

FIG. 9 is a cross sectional view of the structure of a cleaning unit which is disposed in a substrate processing apparatus according to a second embodiment of the invention. In the first embodiment described above, the SC1 cleaning is executed as the physical and/or the chemical cleaning, and the preprocessing (liquid film formation and freezing the liquid film) prior to the SC1 cleaning to thereby assist the particle removal effect of the SC1 cleaning. However, in this second embodiment, a cleaning with droplets using a two-fluid nozzle (droplets cleaning) is executed as the physical and/or the chemical cleaning, and the preprocessing is executed prior to the droplets cleaning to thereby assist the particle removal effect of the droplets cleaning. A major difference of a cleaning unit 1A which is disposed in the substrate processing apparatus according to the second embodiment from the first embodiment is that a droplet supplier 60 is newly added which supplies droplets to a substrate surface. The blocking member 21 has retracted to the retract position which is above the spin chuck 11, which FIG. 9 omits showing. The other structure and operation are similar to those according to the first embodiment, and therefore, will be denoted at the same reference symbols but will not be described.

For the purpose of supplying to a surface of a substrate W which is driven into rotations droplets generated by mixing nitrogen gas (which corresponds to the “gas” in the invention) with the DIW which serves as a processing liquid, the droplet supplier 60 comprises a two-fluid nozzle 61. The two-fluid nozzle 61 is arranged above the spin chuck 11 in such a posture which secures that DIW supplied toward the substrate W from the two-fluid nozzle 61 is approximately parallel to the normal line to the substrate W (which is in the up and down direction in FIG. 9). The two-fluid nozzle 61 is fixed to the tip end of one arm 62, and a nozzle moving mechanism 63 is linked to a base end of the arm 62. As the nozzle moving mechanism 63 operates in response to a control command from the control unit 4, the arm 62 swings about a predetermined center of rotation axis. Hence, the nozzle moving mechanism 63, while maintaining its posture described above, moves the two-fluid nozzle 61 approximately parallel to the surface of the substrate.

The two-fluid nozzle 61 is connected via a pipe 64 to a DIW supply source 64S which functions as the “processing liquid supply source” of the invention, and receives supply of the DIW from the DIW supply source 64S. A valve 64V which can be adjusted to a desired degree of openness is interposed in the pipe 64, which makes it possible to adjust, in accordance with a command from the control unit 4, opening and closing of a channel for the DIW supplied to the two-fluid nozzle 61 and the flow rate and the flow velocity of the DIW. The two-fluid nozzle 61 receives via a pipe 65 supply of high-pressure nitrogen gas as well from a nitrogen gas supply source 65S which functions as the “gas supply source” of the invention. A valve 65V which can be adjusted to a desired degree of openness is interposed in the pipe 65, which makes it possible to adjust, in accordance with a command from the control unit 4, opening and closing of a channel for the nitrogen gas supplied to the two-fluid nozzle 61 and the flow rate and the flow velocity of the nitrogen gas. As the control unit 4 controls the valves 64V and 65V in this fashion, the flow rates and the flow velocities of the DIW and the nitrogen gas supplied to the two-fluid nozzle 61 are adjusted. Receiving supply of the DIW and the nitrogen gas whose flow rates are adjusted, the two-fluid nozzle 61 generates droplets of the DIW and supplies the droplets toward the substrate W.

FIG. 10 is a drawing which shows the structure of the two-fluid nozzle which is disposed in the cleaning unit 1A. This embodiment uses the two-fluid nozzle of the so-called external mixing type which collides the DIW and the nitrogen gas in air (outside the nozzle) and generates droplets of the DIW. A processing liquid discharge nozzle 612, which has a processing liquid discharging outlet 612a inside a body section 611, is inserted in the two-fluid nozzle 61. The processing liquid discharging outlet 612a is disposed at a top surface part 611b of an umbrella part 611a of the two-fluid nozzle 61. Hence, supplied from the DIW supply source 64S through the processing liquid pipe 64, the DIW is discharged toward the substrate W from the processing liquid discharging outlet 612a. In this embodiment, the processing liquid discharge nozzle 612 thus functions as the “processing liquid discharger” of the invention.

Further, a gas discharge nozzle 613 is disposed as the “gas discharger” of the invention in the vicinity of the processing liquid discharge nozzle 612, defining a ring-shaped gas channel which surrounds the processing liquid discharge nozzle 612. The tip end of the gas discharge nozzle 613 is tapered progressively thin, and the opening of this nozzle is opposed against the surface of the substrate W. Hence, supplied from the nitrogen gas supply source 65S via the pipe 65, the nitrogen gas is discharged toward the substrate W from the gas discharging outlet 613a of the gas discharge nozzle 613. The track of thus discharged nitrogen gas intersects that of the DIW discharged from the processing liquid discharging outlet 612a. That is, the liquid (DIW) flow from the processing liquid discharging outlet 612a collides with the gas (nitrogen gas) flow at a collision section G which is located within a mixing region. The gas flow is discharged so as to converge at the collision section G. The mixing region is a space at the bottom end of the body section 611. Hence, the nitrogen gas colliding the DIW quickly changes the DIW into droplets, immediately near the discharging direction in which the DIW is discharged from the processing liquid discharging outlet 612a. Cleaning droplets are generated in this manner. In this embodiment, the processing liquid discharging outlet 612a and the gas discharging outlet 613a do not have to be flush with each other within the top surface part 611b of the two-fluid nozzle 61, and one of the two may project beyond the other.

In the substrate processing apparatus in which the cleaning unit 1A having the above structure is disposed, when the substrate W subjected to the freezing processing is transported to the cleaning unit 1A and held by the spin chuck 11, the motor 13 rotates the substrate W which is held by the spin chuck 11. While the nozzle moving mechanism 63 moves the two-fluid nozzle 61 over the substrate W, the two-fluid nozzle 61 jets out droplets of the DIW toward the top surface of the substrate W. Further, while supplying droplets of the DIW to the surface of the substrate W, the two-fluid nozzle 61 pivots between a position opposed against the center of the substrate W and a position opposed against a periphery edge portion of the substrate W. This collides droplets of the DIW with the entire surface of the substrate W and removes the frozen film which is present on the surface of the substrate. In short, the kinetic energy of droplets of the DIW physically removes particles adhering to the surface of the substrate W together with the frozen film.

As described above, according to this embodiment, cleaning which utilizes the kinetic energy of droplets is executed. But, freezing of a liquid film (water film) adhering to the surface of the substrate which is performed as the preprocessing prior to the droplets cleaning assists the particle removal effect of the droplets cleaning in the following manner. That is, during cleaning with droplets, droplets are collided with particles adhering to the surface of the substrate utilizing the kinetic energy of the droplets and the particles are removed off from the surface of the substrate. At this stage, the stronger the adherence of the particles to the surface of the substrate, the greater the energy (kinetic energy) separating the particles from the surface of the wafer needs be. However, if the kinetic energy of the droplets is increased for the purpose of providing the particles this energy, fine patterns formed on the surface of the substrate, too, will be knocked down. Noting this, the liquid film adhering to the surface of the substrate is frozen as the preprocessing prior to the droplets cleaning, thereby weakening the adherence of the particles to the surface of the wafer in advance and further separating the particles from the surface of the substrate into the frozen film. This makes even such droplets whose kinetic energy is relatively low easily remove the particles off from the surface of the substrate. It is therefore possible to improve the removal rate of the particles without damaging the substrate W.

<Others>

The invention is not limited to the embodiments described above but may be modified in various manners in addition to the embodiments above, to the extent not deviating from the object of the invention. For instance, in the embodiments above, the liquid film formation process and the film removal process after freezing are executed in the cleaning units 1 or 1A. However, separate units may respectively perform the liquid film formation process and the film removal process. Such permits use of appropriate structures to the respective processing, which in turn improves the processing capability and simplifies the structures of the units.

Further, in the embodiments above, the liquid film formation process and the film removal process after freezing are executed in the cleaning units 1 or 1A, whereas the freezing is executed in the freezing unit 2. However, the liquid film formation, freezing, and the film removal may be executed inside one substrate processing apparatus (processing chamber). At this stage, in such a substrate processing apparatus, the following liquid film freezing method may be used for freezing a liquid film which is formed on the surface of the substrate. In the apparatus described in JP-A-3-145130 for instance, a substrate is housed a processing chamber and the substrate is supported on a pedestal (seating stage). A removal fluid such as steam and ultra pure vapor is then supplied to a surface of the substrate. This forms a liquid film of the removal fluid on the surface of the substrate. Following this, cooling gas whose temperature is lower than the freezing temperature of the removal fluid is introduced into the processing chamber so that the cooling gas circulates inside the processing chamber. This freezes the liquid film which is present on the surface of the substrate and forms a frozen layer (frozen film) all over the surface of the substrate.

By the way, in the apparatus described in JP-A-3-145130, the cooling gas is introduced into the processing chamber and made circulate inside the processing chamber to thereby form the frozen layer on the surface of the substrate. This allows the cooling gas to cool not only the substrate but peripheral members as well (hereinafter referred simply as the “substrate peripheral members”) which are located around the substrate, including a substrate holder such as the pedestal, down to or below the freezing temperature or to a temperature near the freezing temperature. As a result, the substrate peripheral members are damaged by the cold energy and the durability of the substrate peripheral members deteriorates, which is a problem. Particularly in the event that a liquid film needs be frozen and a substrate needs be treated with a chemical solution within the same processing chamber, for prevention of corrosion of the substrate peripheral members by the chemical solution, it is necessary to form the substrate peripheral members of a material which is chemical-resistant. For this reason, the substrate peripheral members are often made mainly of chemical-resistant resin materials. However, where the substrate peripheral members are made of such resin materials, it is difficult to secure the resistance against cold energy of the substrate peripheral members, and therefore, leaving a risk that the durability of the substrate peripheral members will deteriorate significantly depending upon the number of times liquid film freezing is performed, the processing time, etc.

Therefore, it has been desired that the frozen film is formed on the entire substrate surface while suppressing the deterioration of the substrate peripheral members. Consequently, in order to meet such needs, the substrate processing apparatus is structured as follows (third to sixth embodiments).

### Third Embodiment

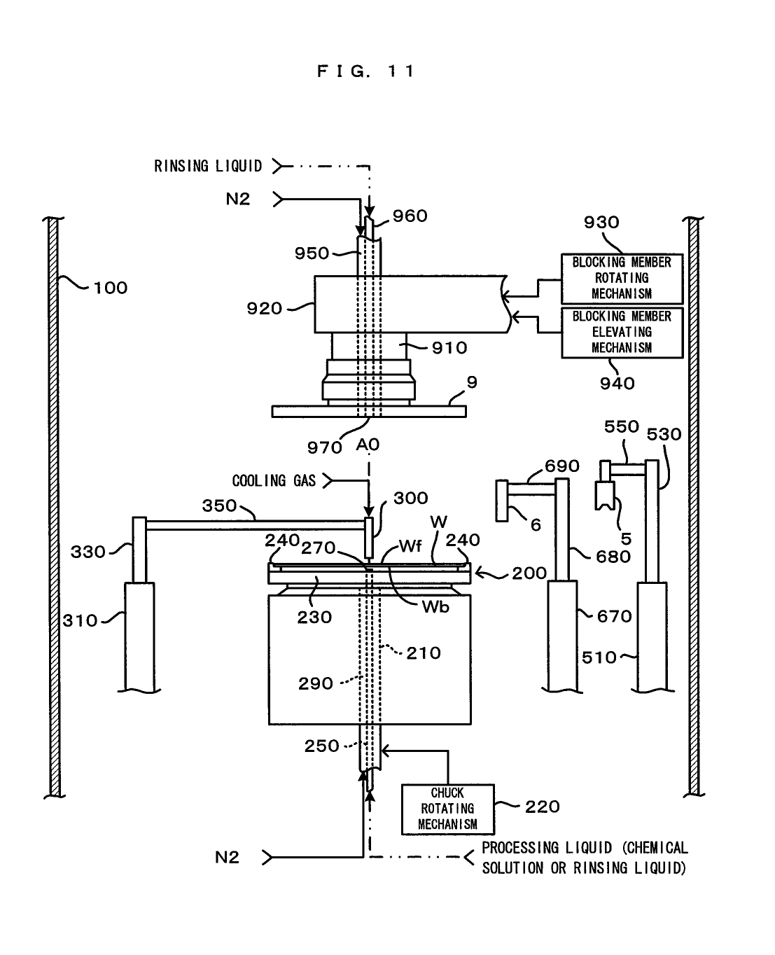

FIG. 11 is a diagram showing a substrate processing apparatus of a third embodiment of the invention. FIG. 12 is a block diagram showing a control construction of the substrate processing apparatus shown in FIG. 11. This substrate processing apparatus is a single wafer type substrate processing apparatus that is used for the cleaning processes for the purpose of removing contaminants such as particles adhering to a surface Wf of a substrate W such as semiconductor wafer. More specifically, this is an apparatus which forms a liquid film on the substrate surface Wf on which fine patterns are formed, then freezes the liquid film, and then removes the liquid film which has been processed freezing (frozen film) from the substrate surface Wf, that is, the apparatus performs a series of cleaning process (liquid film formation+freezing the liquid film+film removal) to a substrate W.

This substrate processing apparatus includes a processing chamber 100 which has a processing space inside in which a cleaning process is performed to a substrate W. In the processing chamber 100, a spin chuck 200, a cooling gas discharge nozzle 300, a two-fluid nozzle 5, chemical solution discharge nozzle 6, and a blocking member 9 are provided. The spin chuck 200 holds the substrate W in an approximately horizontally such that the substrate surface Wf is directed toward above and rotates the substrate W. The cooling gas discharge nozzle (corresponding to “freezing mechanism” of the invention) 300 discharges cooling gas for freezing a liquid film toward the surface Wf of the substrate W held by the spin chuck 200. The two-fluid nozzle 5 supplies droplets of processing liquid to the substrate surface Wf. The chemical solution discharge nozzle (corresponding to “supplier” of the invention) 6 discharges chemical solution toward the surface Wf of the substrate W held by the spin chuck 200. The blocking member 9 is disposed facing the surface Wf of the substrate W held by the spin chuck 200. As processing liquid, chemical solution or rinsing liquid such as purified water and DIW (deionized water) or the like are used.

A rotation column 210 of the spin chuck 200 is linked to a rotation shaft of a chuck rotating mechanism 220 which contains a motor. The spin chuck 200 is rotatable about a rotation center A0 when driven by the chuck rotating mechanism 220. A disk-shaped spin base 230 is linked by a fastening component such as a screw to a top end portion of the rotation column 210 as one integrated unit. The spin base 230 therefore rotates about the rotation center A0 when driven by the chuck rotating mechanism 220 in response to an operation command received from a control unit 400 (FIG. 12) which controls the apparatus as a whole. Thus, in this embodiment, the chuck rotating mechanism 220 functions as a “rotator” of the invention.

Plural chuck pins 240 for holding the substrate W at the rim thereof are disposed upright in the vicinity of the rim of the spin base 230. There may be three or more chuck pins 240 to securely hold the disk-shaped substrate W, and the chuck pins 240 are arranged at equal angular intervals along the rim of the spin base 230. Each chuck pin 240 comprises a substrate support part which supports the substrate W at the rim thereof from below and a substrate holding part which presses the substrate W at the outer peripheral edge surface thereof to hold the substrate W. Each chuck pin 240 is structured so as to be capable of switching between a pressing state that the substrate holding part presses the substrate W at the outer peripheral edge surface thereof and a released state that the substrate holding part stays away from the outer peripheral edge surface of the substrate W.

The plural chuck pins 240 are in the released state while the substrate W is being transferred to the spin base 230 but in the pressing state for cleaning of the substrate W. When in the pressing state, the plural chuck pins 240 hold the substrate W at the rim thereof and keep the substrate approximately horizontally at a predetermined distance from the spin base 230. The substrate W is held with its front surface (pattern-formed surface) Wf directed toward above and its back surface Wb toward below.

A first motor 310 is disposed at a place outward from the spin chuck 200. A first rotary shaft 330 is connected to the first motor 310. Further, a first arm 350 extending horizontally is linked to the first rotary shaft 330, and the cooling gas discharge nozzle 300 is attached to the end of the first arm 350. The first motor 310 is driven in accordance with an operation command from the control unit 400, whereby the first arm 350 swings around the first rotary shaft 330.

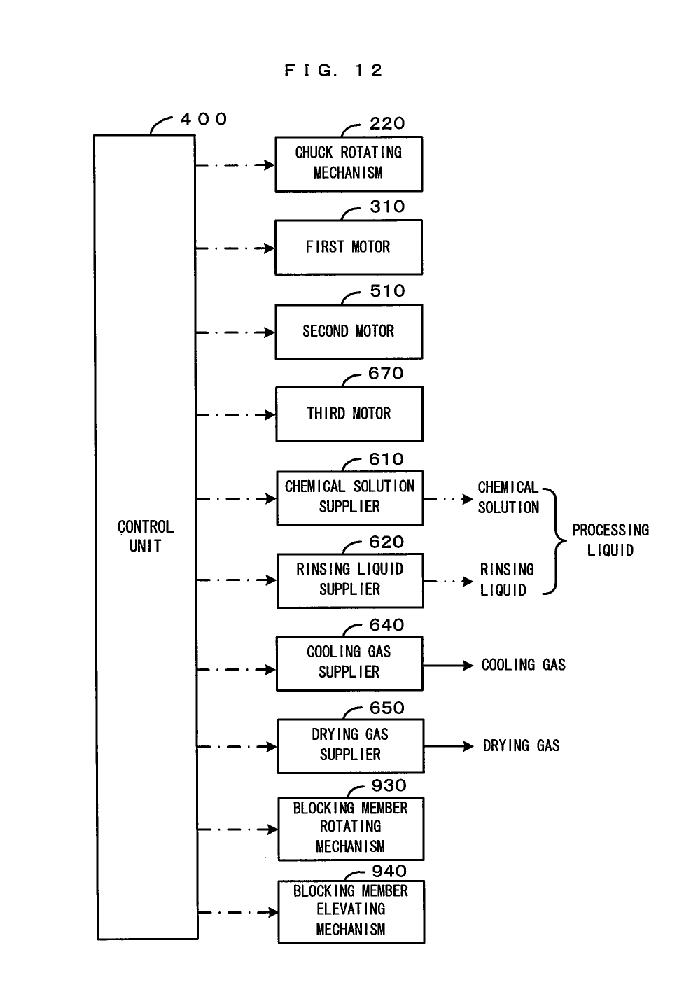

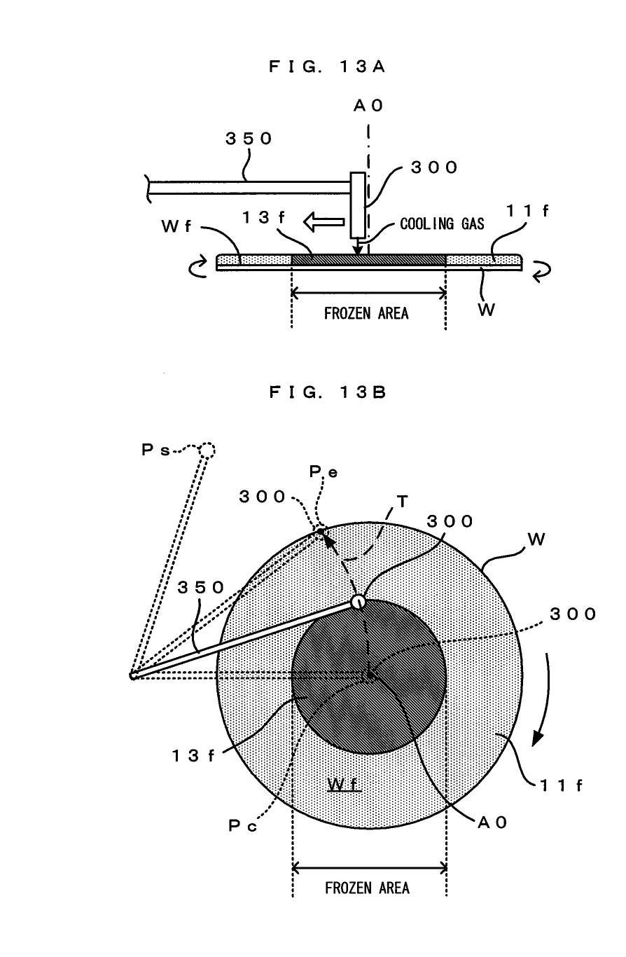

FIGS. 13A and 13B are diagrams showing an operation of the cooling gas discharge nozzle equipped in the substrate processing apparatus shown in FIG. 11. To be more specific, FIG. 13A is a side view of the cooling gas discharge nozzle and FIG. 13B is a plan view thereof. When the first motor 310 is driven to swing the first arm 350, the cooling gas discharge nozzle 300 moves along a moving trajectory T in FIG. 13B while facing the substrate surface Wf, that is, along the trajectory T from a rotational center position Pc of the substrate W toward an edge position Pe of the substrate W. The rotational center position Pc is located above the rotation center A0 of the substrate W facing the substrate surface Wf. Further, the cooling gas discharge nozzle 300 is movable to a standby position Ps which is located away from the substrate W and sideward thereof.

The cooling gas discharge nozzle 300 is connected to a cooling gas supplier 640 (FIG. 12). The cooling gas supplier 640 supplies a cooling gas to the cooling gas discharge nozzle 300 in accordance with an operation command from the control unit 400. Hence, when the cooling gas discharge nozzle 300 is positioned facing the substrate surface Wf, the cooling gas is discharged from the cooling gas discharge nozzle 300 toward the substrate surface Wf locally. Therefore, in a state that the cooling gas is discharged from the cooling gas discharge nozzle 300, the control unit 400 moves the cooling gas discharge nozzle 300 along the moving trajectory T while rotating the substrate W, whereby the cooling gas is supplied to the entire substrate surface Wf. With this, when a liquid film is formed on the substrate surface Wf as described hereinafter, the entire liquid film 11f can be frozen to form a frozen film 13f on the entire substrate surface Wf.

The height of the cooling gas discharge nozzle 300 from the substrate surface Wf is different depending upon the supplying amount of the cooling gas, but may be set not more than 50 mm for instance and preferably about several mm. Such height of the cooling gas discharge nozzle 300 from the substrate surface Wf and the supplying amount of the cooling gas is determined experimentally from a viewpoint of (1) coldness the cooling gas has gives the liquid film efficiently, (2) the liquid film is frozen stably without distorting the surface of the liquid film by the cooling gas.

A gas whose temperature is below the freezing point of the liquid which composes the liquid film 11f formed on the substrate surface Wf, for example, nitrogen gas, oxygen gas, clean air, and the like are used as the cooling gas. It is easy to eliminate contaminants contained in the cooling gas by a filter and the like before supplying the gas to the substrate surface Wf when such cooling gas is used. Therefore, it is possible to prevent from contaminating the substrate surface Wf in freezing the liquid film 11f. In this embodiment, in a state that the liquid film 11f with DIW is formed on the substrate surface Wf the cooling gas is discharged from the cooling gas discharge nozzle 300 toward the substrate surface Wf, whereby the liquid film 11f is frozen. Therefore, the cooling gas adjusted to the temperature below the freezing point of DIW which composes the liquid film 11f is used.

Further, a second motor 510 is disposed at a place outward from the spin chuck 200. A second rotary shaft 530 is connected to the second motor 510. Further, a second arm 550 is linked to the second rotary shaft 530, and the two-fluid nozzle 5 is attached to the end of the second arm 550. The second motor 510 is driven in accordance with an operation command from the control unit 400, whereby the two-fluid nozzle 5 swings around the second rotary shaft 530. The two-fluid nozzle 5 discharges droplets of processing liquid for cleaning the substrate surface Wf, the droplets generated by mixing processing liquid and gas. Meanwhile, the structure of the two-fluid nozzle 5 is the same as the two-fluid nozzle 61 shown in FIG. 10 and the detailed description is skipped here.

The rotation column 210 of the spin chuck 200 is formed by a hollow shaft. A processing liquid supply pipe 250 is inserted in the rotation column 210 to thereby supply the processing liquid to the back surface Wb of the substrate W. The processing liquid supply pipe 250 extends to a position which is in the vicinity of the bottom surface (back surface Wb) of the substrate W which is held by the spin chuck 200, and the tip end of the processing liquid supply pipe 250 mounts a processing liquid nozzle 270 which discharges the processing liquid toward a central area in the bottom surface of the substrate W. The processing liquid supply pipe 250 is connected to a processing liquid supplier 610 and a rinsing liquid supplier 620. A chemical solution such as an SC1 solution (a liquid mixture of aqueous ammonia and a hydrogen peroxide solution) from the processing liquid supplier 610, or a rinsing liquid such as DIW from the rinsing liquid supplier 620 is supplied selectively to the processing liquid supply pipe 250.

Further, a clearance between the inner wall surface of the rotation column 210 and the outer wall surface of the processing liquid supply pipe 250 forms a cylindrical gas supply passage 290. This gas supply passage 290 is connected to a dry gas supplier 650, so that nitrogen gas as the dry gas can be supplied to a space between the spin base 230 and the substrate back-surface Wb. Although nitrogen gas is supplied from the dry gas supplier 650 in this embodiment, air or another inert gas may be discharged.

A third motor 670 is disposed at a place outward from the spin chuck 200. A third rotary shaft 680 is connected to the third motor 670. Further, a third arm 690 extending horizontally is linked to the third rotary shaft 680, and the chemical solution discharge nozzle 6 is attached to the end of the third arm 690. The third motor 670 is driven in accordance with an operation command from the control unit 400, whereby the chemical solution discharge nozzle 6 moves in reciprocation between a discharging position above the rotation center A0 of the substrate W and a stand-by position away sideward from the discharging position. The chemical solution discharge nozzle 6 is connected to the chemical solution supplier 610. A chemical solution such as the SC1 solution is pressure fed to the chemical solution discharge nozzle 6 in accordance with an operation command from the control unit 400.

Further disposed above the spin chuck 200 is a disk-shaped blocking member 9 which has an opening at its center. The back surface (bottom) of the blocking member 9 is a substrate-facing surface which faces the front substrate surface Wf approximately parallel, and the size in plan view of this surface is equal to or greater than the diameter of the substrate W. The blocking member 9 is attached approximately horizontally to the lower end of a support shaft 910 which is shaped approximately like a circular cylinder, and an arm 920 extending in the horizontal direction holds the support shaft 910 so that the support shaft 910 can rotate about a vertical axis which penetrates the center of the substrate W. Further, a blocking member rotating mechanism 930 and a blocking member elevating mechanism 940 are connected to the arm 920.

The blocking member rotating mechanism 930 rotates the support shaft 910 in response to an operation command from the control unit 400 about the vertical axis which penetrates the center of the substrate W. Further, the blocking member rotating mechanism 930 is structured so as to rotate the blocking member 9 at about the same rotation speed in the same direction as the substrate W in accordance with rotation of the substrate W which is held by the spin chuck 200.

Further, the blocking-member elevating mechanism 940 moves the blocking member 9 toward the spin base 230 to face the spin base 230, and conversely, away therefrom in accordance with an operation command from the control unit 400. Specifically, the control unit 400 causes the blocking member 9 to move upward to a separated position (position shown in FIG. 11) above the spin chuck 200 upon loading and unloading the substrate W into and from the substrate processing apparatus by actuating the blocking-member elevating mechanism 940. On the other hand, the control unit 400 causes the blocking member 9 to move downward to a specified facing position set very close to the surface Wf of the substrate W held by the spin chuck 200 upon performing a predetermined processing to the substrate W.

The support shaft 910 is formed hollow and accepts penetration by a gas supply path 950 which links to the opening of the blocking member 9. The gas supply path 950 is connected with the drying gas supplier 650 so that nitrogen gas is supplied from the drying gas supplier 650. In this embodiment, nitrogen gas is supplied via the gas supply path 950 to the space which is formed between the blocking member 9 and the front surface Wf of the substrate, during drying of the substrate W after cleaning. In addition, a liquid supply path 960 linking to the opening of the blocking member 9 is inserted inside the gas supply path 950, and a nozzle 970 is coupled with the lower end of the liquid supply path 960. The liquid supply path 960 is connected with the rinsing liquid supplier 620. When the rinsing liquid is supplied from the rinsing liquid supplier 620, the nozzle 970 can jet out the rinsing liquid toward the front surface Wf of the substrate.

The cleaning operation in the substrate processing apparatus having the structure above will now be described with reference to FIG. 14. FIG. 14 is a flow chart of the operation in the substrate processing apparatus shown in FIG. 11. In this apparatus, upon loading of the substrate W into inside the apparatus, the control unit 400 controls the respective sections of the apparatus and a series of cleaning processing (liquid film formation+liquid film freezing+film removal) is performed upon the substrate W. In some instances, fine patterns are formed on the front surface Wf of the substrate. In other words, the front surface Wf of the substrate is a pattern-formed surface. Noting this, in this embodiment, the substrate W is loaded into inside the processing chamber 100 with the front surface Wf of the substrate directed toward above, and held by the spin chuck 200 (Step S21). Meanwhile, the blocking member 9 is located at the separated position, which obviates interference with the substrate W.

As the spin chuck 200 holds an unprocessed substrate W, the blocking member 9 descends to the opposed position and becomes positioned close to the front surface Wf of the substrate. The front surface Wf of the substrate is therefore covered as it is located in the vicinity of the substrate-facing surface of the blocking member 9, and is blocked from the surrounding atmosphere around the substrate W. The control unit 400 then drives the chuck rotating mechanism 220, whereby the spin chuck 200 rotates and the nozzle 970 supplies the DIW to the front surface Wf of the substrate. Centrifugal force which develops as the substrate W rotates acts upon the DIW supplied to the front surface Wf of the substrate, and the DIW spreads uniformly outward in the diameter direction of the substrate W and partially flies away off from the substrate. This controls the thickness of the liquid film uniform all across the entire front surface Wf of the substrate, and forms the liquid film (aqueous film) which has a predetermined thickness all over the front surface Wf of the substrate (Step S22; liquid film forming step). As for liquid film formation, to drain the front surface Wf of the substrate off of the DIW supplied thereto as described above is not an essential requirement. For instance, in a condition that the substrate W has stopped rotating or is rotating relatively slowly, a liquid film may be formed on the front surface Wf of the substrate without draining the substrate W off of the DIW.

After the liquid film forming step, the control unit 400 positions the blocking member 9 to the separated position and moves the cooling gas discharge nozzle 300 to a cooling gas supply start position, namely the rotational center position Pc, from the stand-by position Ps. While discharging the cooling gas toward the front surface Wf of the rotating substrate W, the cooling gas discharge nozzle 300 then moves gradually toward the edge position Pe of the substrate W. As a result, as shown in FIG. 13, of the surface region of the front surface Wf of the substrate, an area where the liquid film 11f has been frozen (frozen area) expands toward the periphery edge from the center of the front surface Wf of the substrate, and a frozen film 13f is formed all over the front surface Wf of the substrate (Step S23; liquid film freezing step). While it is possible to suppress an uneven distribution of the liquid film thickness and accordingly form the frozen film 13f all over the front surface Wf of the rotating substrate since the substrate W remains rotating while the cooling gas discharge nozzle 300 moves, if the substrate W rotates at a high speed, air flows developed by the rotations of the substrate W diffuse the cooling gas which is ejected from the cooling gas discharge nozzle 300 and the efficiency of freezing of the liquid film worsens, and therefore, the rotation speed of the substrate W at the liquid film freezing step is set to 1 through 300 rpm for example. The rotation speed of the substrate W is determined considering the traveling speed of the cooling gas discharge nozzle 300, the temperature and the flow rate of the discharged gas and the thickness of the liquid film as well.

When the liquid film freezing step is executed in this way, the cubic volume of the liquid film entering between the front surface Wf of the substrate and the particles increases (when water of 0° C. becomes ice of 0° C., the volume thereof increases by about 1.1 times), and particles move away extremely short distances from the front surface Wf of the substrate. This reduces the adherence between the front surface Wf of the substrate and the particles and further separates the particles from the front surface Wf of the substrate. When this occurs, even though there are fine patterns formed on the front surface Wf of the substrate, the pressure upon the patterns owing to the cubical expansion of the liquid film is equal in all directions, that is, the force applied upon the patterns gets offset. Hence, it is possible to remove only the particles off from the front surface Wf of the substrate, focusing selectively on the particles and without peeling off or destroying the patterns.

Upon freezing of the liquid film, the control unit 400 moves the cooling gas discharge nozzle 300 to the stand-by position Ps and positions the blocking member 9 to the opposed position. The nozzle 970 and the processing liquid nozzle 270 supply the DIW as the rinsing liquid respectively to the front surface Wf and the back surface Wb of the substrate W before the frozen film 13f has been melted. This permits the DIW defrost the frozen film which is on the front surface Wf of the substrate. Further, the centrifugal force which develops as the substrate W rotates acts upon the frozen film 13f and the DIW supplied to the front surface Wf of the substrate. In consequence, the frozen film 13f containing the particles is removed from the front surface Wf of the substrate and discharged to outside the substrate (Step S24; film removal step). In addition, as for the back surface Wb of the substrate W as well, the DIW spreads all over the back surface as the substrate W rotates, whereby the back surface Wb of the substrate W is rinsed. At the film removal step, it is preferable that the blocking member 9 rotates as the substrate W rotates. The blocking member 9 is therefore drained off of the liquid component adhering thereto, and it is possible to prevent the processing liquid in the mist form from intruding from around the substrate into the space which is generated between the blocking member 9 and the front surface Wf of the substrate.

Alternatively, the frozen film may be defrosted and removed at the film removal step as follows. That is, after freezing of the liquid film, the control unit 400, with the blocking member 9 located at the separated position, makes the two-fluid nozzle 5 supply DIW droplets to the front surface Wf of the substrate while pivoting over the substrate W. This collides droplets with particles adhering to the front surface Wf of the substrate, and due to the kinetic energy of the droplets, the particles are physically removed (physical cleaning). This makes it easy to remove particles off from the front surface Wf of the substrate and realizes excellent cleaning of the front surface Wf of the substrate. In this modification, the two-fluid nozzle 5 functions as the “cleaning mechanism” of the invention.

After the film removal step thus finishes and cleaning of the substrate W (liquid film formation+liquid film freezing+film removal) completes (YES at Step S25), drying of the substrate W is carried out. On the other hand, depending on the surface condition of the front surface Wf of the substrate which is a surface-to-be-processed or the particle diameters and the type of particles which must be removed, the particles may not be removed sufficiently off from the front surface Wf of the substrate through one cleaning. When this occurs (NO at Step S25), the film removal step is followed by re-execution of the liquid film freezing step and the film removal step. That is, after the film removal step, the rinsing liquid (DIW) remains adhering to the front surface Wf of the substrate. The front surface Wf of the substrate is therefore coated with a liquid film of the rinsing liquid, even without formation of a new liquid film on the front surface Wf of the substrate. Hence, if the liquid film freezing step is executed after the film removal step, a frozen film of the rinsing liquid is formed. When the frozen film is removed at the film removal step, the particles adhering to the front surface Wf of the substrate are removed together with the frozen film off from the front surface Wf of the substrate. Through repeated execution of the film removal step and the liquid film freezing step over a predetermined number of times, the particles are removed off from the front surface Wf of the substrate. The number of re-executions may be determined in advance as a processing recipe, and the film removal step and the liquid film freezing step may be repeated over thus determined number of times according to a processing recipe which is chosen appropriately.

Upon cleaning of the substrate W, the control unit 400 increases the rotation speeds of the motors for the chuck rotating mechanism 220 and the blocking member rotating mechanism 930 and makes the substrate W and the blocking member 9 rotate at high speeds. This attains drying (spin drying) of the substrate W (Step S26). During this drying processing, nitrogen gas is supplied on the gas supply paths 950 and 290, thereby generating a nitrogen gas atmosphere in the space which is sandwiched between the blocking member 9 and the front surface Wf of the substrate and the space which is sandwiched between the spin base 230 and the back surface Wb of the substrate. This facilitates drying of the substrate W and shortens the drying time. After the drying processing, the substrate W stops rotating and the processed substrate W is taken out from the processing chamber 100 (Step S27).

As described above, in this embodiment, the cooling gas discharge nozzle 300 discharges, toward a local section of the front surface Wf of the substrate, the cooling gas whose temperature is lower than the freezing point of the liquid which forms the liquid film 11f formed on the front surface Wf of the substrate. The cooling gas discharge nozzle 300 then moves between the rotational center position Pc of the substrate W and the edge position Pe of the substrate W while the substrate W remain rotating, whereby the frozen film 13f is formed all over the front surface Wf of the rotating substrate. This limits a section receiving supply of the cooling gas to a very narrow area on the front surface Wf of the substrate, which in turn minimizes a decrease of the temperatures of the substrate peripheral members such as the spin chuck 200. It is therefore possible to form the frozen film 13f all over the front surface Wf of the rotating substrate while suppressing deterioration of the durability of the substrate peripheral members. As a result, even when the substrate peripheral members are made of a resin material (a chemical-resistant resin material) with which it is hard to secure the resistance against cold energy, degradation of the material of the substrate peripheral members can be suppressed.

Further, this embodiment makes it easy to deal with frost formed inside the processing chamber 100 since the liquid film 11f is frozen while the cooling gas is discharged toward a local section of the front surface Wf of the substrate. In other words, since frost grows only at the cooling gas discharge nozzle 300 and surrounding areas, it is easier to suppress frost as compared to where the cooling gas is circulated inside the processing chamber 100. For example, growth of frost is discouraged relatively easily when nozzle side surfaces of the cooling gas discharge nozzle 300 are covered with a thermal insulating material. Alternatively, the cooling gas discharge nozzle 300 may have a double pipe structure that carries the cooling gas on the inner side (through a central section) and carries a gas on the outer side (at the periphery edge), which easily suppresses formation of frost.

Further, according to this embodiment, the film removal step and the liquid film freezing step are executed continuously inside the same processing chamber 100, the throughput is improved. In addition, since the substrate W is cooled locally in this embodiment, it is possible to shorten the time necessary for removal of the frozen film than conventional techniques which demand circulating cooling gas inside a processing chamber for cooling of a substrate W do. That is, according to the conventional techniques, cold energy accumulates at substrate peripheral members including a substrate holder during cooling of a substrate W and it is therefore necessary to increase the temperatures of the substrate peripheral members as well during removal of a frozen film. In contrast, according to the invention, it is possible to remove the frozen film off from the substrate W in a relatively short period of time since cold energy does not accumulate at the substrate peripheral members beyond a necessary extent. Further, since the liquid film forming step is carried out inside the same processing chamber 100 according to this embodiment, it is possible to perform the series of cleaning processing (liquid film formation+liquid film freezing+film removal) upon the substrate W at a high efficiency as an integrated process. Moreover, as the series of cleaning processing is possible without transporting the substrate W, it is unnecessary to control the schedule of substrate transportation.

Further, according to this embodiment, it is possible to repeatedly perform the liquid film freezing step and the film removal step inside the same processing chamber 100 for the predetermined times. It is therefore possible to securely remove off from the front surface Wf of the substrate those particles which can not be removed from the front surface Wf of the substrate through only single execution of the liquid film freezing step and the film removal step.

Further, according to this embodiment, execution of the film removal step is started before the frozen film has been melted. This makes it possible to prevent particles fallen off from the front surface Wf of the substrate at the liquid film freezing step from re-adhering to the front surface Wf of the substrate again as the frozen film gets melted. It is therefore possible to efficiently remove the particles together with the frozen film off from the front surface Wf of the substrate through execution of the film removal step, which is advantageous in improving the particle removal rate.

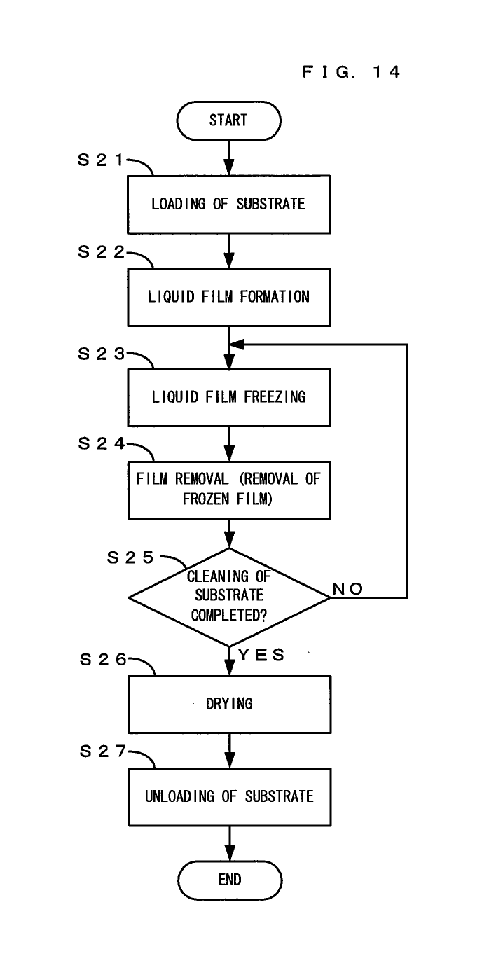

Although the DIW is supplied to the front surface Wf of the substrate for removal of the frozen film in the embodiment described above, the frozen film may be removed through chemical cleaning of the front surface Wf of the substrate as shown in FIG. 15. In other words, after freezing of the liquid film, the control unit 400 positions the chemical solution discharge nozzle 6 at the discharging position and the SC1 solution is pressure fed into the chemical solution discharge nozzle 6. This makes the chemical solution discharge nozzle 6 feed the SC1 solution to the front surface Wf of the substrate. Since the zeta potential (electrokinetic potential) at the surface of the solid matter in the SC1 solution has a relatively large value, when the area between the front surface Wf of the substrate and the particles on the front surface Wf of the substrate is filled with the SC1 solution, significant repulsive force acts between the front surface Wf of the substrate and the particles. This makes it even easier for the particles to fall off from the front surface Wf of the substrate and achieves effective removal of the particles from the front surface Wf of the substrate. In this modification, the chemical solution discharge nozzle 6 functions as the “cleaning mechanism” of the invention.

Further, at the same time as supply of the SC1 solution to the front surface Wf of the substrate, the processing liquid nozzle 270 may supply the SC1 solution to the back surface Wb of the substrate W. This realizes effective removal of even those contaminants adhering to the back surface Wb of the substrate off from the substrate due to the chemical cleaning effect of the SC1 solution. After cleaning with the SC1 solution, the DIW is supplied to the front surface Wf and the back surface Wb of the substrate W and rinsing with the DIW is attained.

### Fourth Embodiment

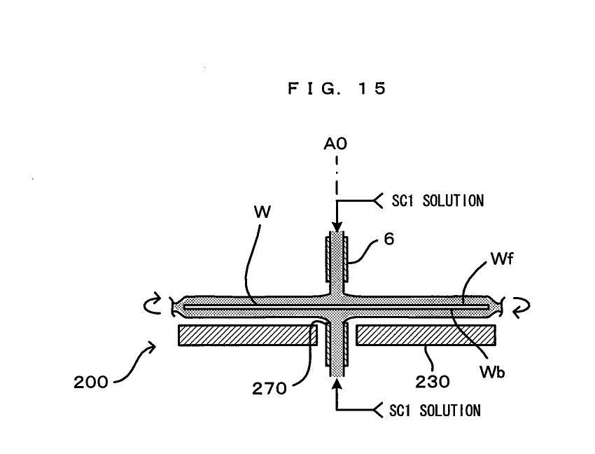

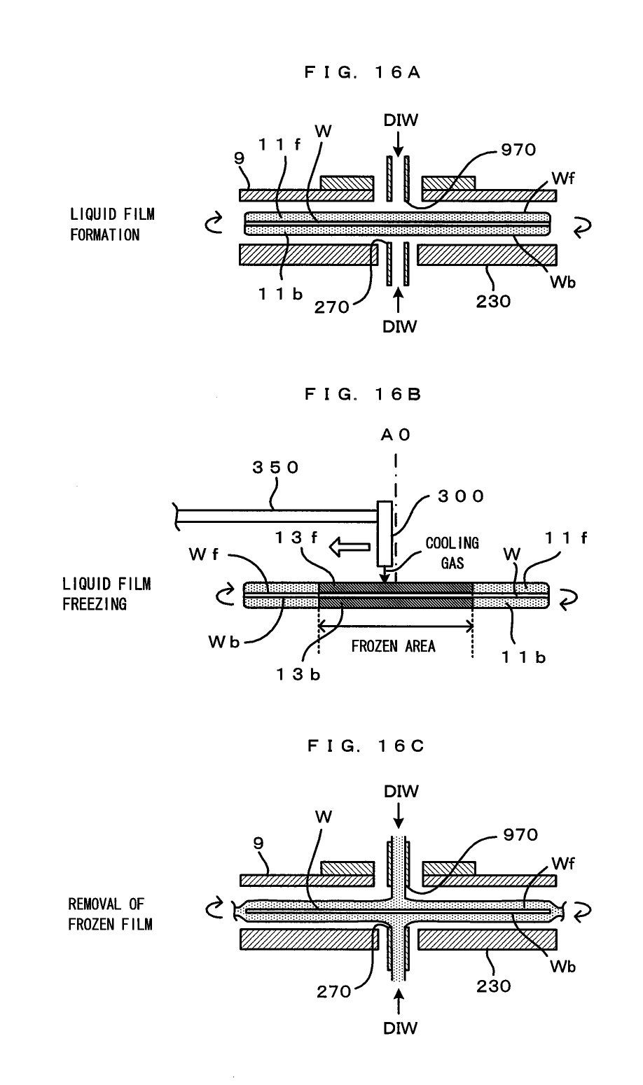

FIGS. 16A, 16B and 16C are drawings of a substrate processing apparatus according to a fourth embodiment of the invention. A major difference of the substrate processing apparatus according to the fourth embodiment from the third embodiment is that a frozen film (back surface side frozen film) is formed on the back surface Wb of the substrate as well, not only on the front surface Wf of the substrate. The other structure and operation are basically similar to those according to the third embodiment, and therefore, will be denoted at the same reference symbols but will not be described.

In this embodiment, concurrently with formation of the liquid film on the front surface Wf of the substrate, a liquid film (back surface side liquid film) 11b is formed on the back surface Wb of the substrate (FIG. 16A). To be more specific, the nozzle 970 supplies the DIW to the front surface Wf of the substrate while the substrate W rotates, during which the processing liquid nozzle 270 supplies the DIW to the back surface Wb of the substrate. As a result, the liquid films (aqueous films) 11f and 11b which have a predetermined thickness are formed entirely over the front surface Wf and the back surface Wb of the substrate.

Following this, as in the third embodiment, the cooling gas discharge nozzle 300 jets out the cooling gas toward a local section of the front surface Wf of the substrate. The cooling gas discharge nozzle 300 then gradually moves toward the edge position Pe of the substrate W from the rotational center position Pc of the substrate W while the substrate W rotates. At this stage, the cold energy of the cooling gas supplied toward the front surface Wf of the substrate is transmitted to the back surface side liquid film 11b via the substrate W. Since a silicon substrate in particular has a relatively large coefficient of thermal conductivity, the cold energy is efficiently transmitted to the back surface side liquid film 11b via the substrate W. This expands an area where the back surface side liquid film 11b has been frozen (frozen area) inside the surface region of the back surface Wb of the substrate, while simultaneously expanding the frozen area on the front surface Wf of the substrate, and forms a frozen film (back surface side frozen film) 13b on the entire back surface Wb of the substrate (FIG. 16B). As a result, the entire front surface Wf and the entire back surface Wb of the substrate are covered with the front surface side frozen film 13f and the back surface side frozen film 13b, respectively. This weakens the adherence between particles and the substrate W not only at the front surface Wf but at the back surface Wb as well.

As the liquid films 11f and 11b are frozen in this manner, the DIW is supplied as the rinsing liquid to the front surface Wf and the back surface Wb of the substrate W, whereby the particles are removed together with the frozen films 13f and 13b off from the front surface Wf and the back surface Wb of the substrate W (FIG. 16C). Alternatively, the frozen films 13f and 13b may be removed by physical cleaning using droplets from the two-fluid nozzle 5 or chemical cleaning with the SC1 solution.

As described above, according to this embodiment, since a section receiving supply of the cooling gas is limited to a local area on the front surface Wf of the substrate, it is possible to form the frozen films 13f and 13b on the front surface Wf and the back surface Wb of the substrate W while suppressing deterioration of the durability of the substrate peripheral members. Further, since the frozen films 13f and 13b are formed on the front surface Wf and the back surface Wb of the substrate W at the same time, the frozen films 13f and 13b are formed on the both surfaces of the substrate W in approximately the same period of time as that required for formation of the frozen film 13f only on the front surface Wf of the substrate.

Further, according to this embodiment, removal of the front surface side frozen film 13f from the front surface Wf of the substrate and removal of the back surface side frozen film 13b as well from the back surface Wb of the substrate are executed. Hence, even when there are particles adhering to the back surface Wb of the substrate, it is possible to effectively remove the particles off from the back surface Wb of the substrate W in a similar fashion to that for the front surface Wf of the substrate. This attains effective removal of the particles from the front surface Wf and the back surface Wb of the substrate W and favorable cleaning of the entire substrate. Further, since the back surface side liquid film 11b is frozen at the same time that the front surface side liquid film 11f is frozen, it is possible to clean the front surface Wf and the back surface Wb of the substrate W without lowering the throughput. That is, since it is possible to clean not only the front surface Wf of the substrate but the back surface Wb of the substrate as well without reversing the substrate W or otherwise appropriate operation, it is possible to clean the front surface Wf and the back surface Wb of the substrate W in approximately the same period of time as that required for cleaning of the front surface Wf of the substrate.

### Fifth Embodiment

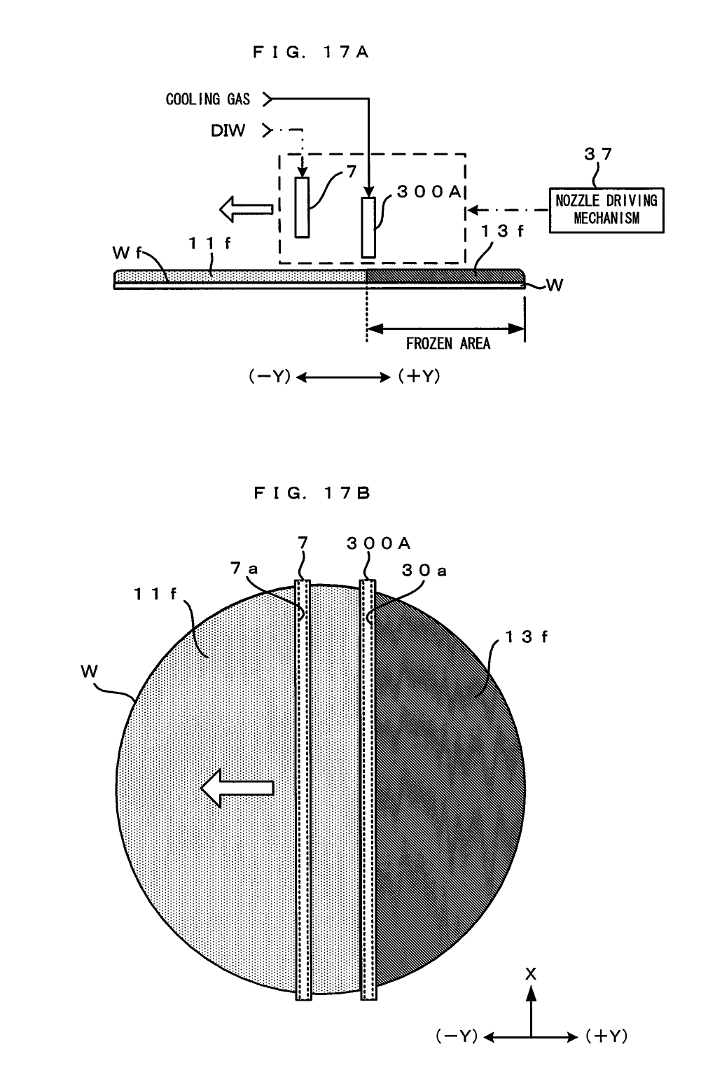

In the third and the fourth embodiments described above, the cooling gas discharge nozzle 300 moves between the rotational center position Pc of the substrate W and the edge position Pe of the substrate W while the substrate W remain rotating, thereby moving the cooling gas discharge nozzle 300 relative to the substrate W. However, the structure for moving the cooling gas discharge nozzle relative to the substrate W is not limited to this. For example, as shown in FIGS. 17A and 17B, the cooling gas discharge nozzle may move relative to the substrate W without rotating the substrate W (fifth embodiment).

FIGS. 17A and 17B are drawings of a substrate processing apparatus according to the fifth embodiment of the invention. To be more specific, FIG. 17A is a side view and FIG. 17B is a plan view. In this apparatus, the substrate holder such as the spin chuck 200 holds the substrate W approximately horizontally in a condition that the front surface Wf of the substrate is directed toward above. Further, a cooling gas discharge nozzle 300A (which corresponds to the “freezing mechanism” of the invention) is disposed in the vicinity of and opposed against the front surface Wf of the substrate. At the tip end (lower end) of the cooling gas discharge nozzle 300A, there is a slit-like discharge outlet 30a which extends in an X-direction. The cooling gas discharge nozzle 300A is connected to a cooling gas supplier (not shown), and jets out at the discharge outlet 30a toward a local area on the front surface Wf of the substrate the cooling gas from the cooling gas supplier in the form of a ribbon. The discharge outlet 30a is as long as or longer than the plane size (substrate diameter) of the front surface Wf of the substrate in the X-direction.

The cooling gas discharge nozzle 300A is arranged so as to able to freely move in an Y-direction which is orthogonal to the X-direction but parallel to the front surface Wf of the substrate, and when driven by a nozzle driving mechanism 37, can reciprocally move in the Y-direction. In this embodiment, as the cooling gas discharge nozzle 300A moves to the left-hand side (−Y) in FIGS. 17A and 17B in the Y-direction, liquid film freezing processing described later is performed. The nozzle driving mechanism 37 may be a known mechanism such as a lead screw mechanism which moves the cooling gas discharge nozzle 300A by means of motor drive along a guide extending in the Y-direction and a ball screw.

A DIW discharge nozzle 7 is disposed, opposed against the front surface Wf of the substrate, on the downstream side (−Y) to the cooling gas discharge nozzle 300A in the direction the cooling gas discharge nozzle 300A moves, to thereby form a liquid film on the front surface Wf of the substrate. The DIW discharge nozzle 7 is connected to a DIW supplier (not shown) and jets out the DIW from the DIW supplier toward the front surface Wf of the substrate. At the tip end (lower end) of the DIW discharge nozzle 7, there is a slit-like discharge outlet 7a which extends in the X-direction so that the DIW discharge nozzle 7 discharges the DIW in the form of a strip toward the front surface Wf of the substrate. The discharge outlet 7a is as long as or longer than the plane size (substrate diameter) of the front surface Wf of the substrate in the X-direction.

The DIW discharge nozzle 7 is capable of moving in the (−Y) direction in synchronization to the cooling gas discharge nozzle 300A. That is, a link mechanism (not shown) links the DIW discharge nozzle 7 with the cooling gas discharge nozzle 300A, and when the nozzle driving mechanism 37 operates, the cooling gas discharge nozzle 300A and the DIW discharge nozzle 7 move in the (−Y) direction as one integrated unit. This maintains the gap between the cooling gas discharge nozzle 300A and the discharging position for the DIW discharge nozzle 7 to a predetermined separation distance while the cooling gas discharge nozzle 300A is moving. As a result, liquid film forming processing described later and the liquid film freezing processing are carried out while maintaining this predetermined separation distance, and hence, it is possible to stabilize the both processing. While an independent driver may be disposed for the DIW discharge nozzle 7 to move the DIW discharge nozzle 7 in association with the cooling gas discharge nozzle 300A, where the single driver moves the DIW discharge nozzle 7 and the cooling gas discharge nozzle 300A as one integrated unit, the drive structure may be simple.

In the substrate processing apparatus having such a structure, as the nozzle driving mechanism 37 operates, the DIW discharge nozzle 7 and the cooling gas discharge nozzle 300A move at a constant speed in the (−Y) direction. Further, the DIW discharge nozzle 7 and the cooling gas discharge nozzle 300A discharge the DIW and the cooling gas, respectively. This realizes coating of the front surface Wf of the substrate with the DIW from the upstream side (+Y) to the downstream side (−Y) in the direction the DIW discharge nozzle 7 moves, as the DIW discharge nozzle 7 moves. In consequence, on the downstream side (−Y) in the moving direction relative to the cooling gas discharge nozzle 300A, the liquid film 11f is formed on the front surface Wf of the substrate. Further, as the nozzle 7 and the cooling gas discharge nozzle 300A move, the cooling gas discharge nozzle 300A jets out the cooling gas toward the front surface Wf of the substrate on which the liquid film 11f is formed and the liquid film 11f gets frozen. This gradually expands in the (−Y) direction an area where the liquid film 11f has been frozen (frozen area) inside the surface region of the front surface Wf of the substrate, and the frozen film 13f is formed on the entire front surface Wf of the substrate.

As described above, this embodiment permits formation of the frozen film 13f on the entire front surface Wf of the substrate utilizing the simple structure which does not require rotating the substrate W. Further, since the liquid film 11f is formed at the same time that the liquid film 11f is frozen (formation of the frozen film 13f), the processing efficiency is high through the liquid film forming processing and the liquid film freezing processing.

Further, since the film removal processing is executed in a similar manner to that according to the third embodiment after freezing the liquid film, it is possible to efficiently perform the series of cleaning processing (liquid film formation+liquid film freezing+film removal) upon the substrate W. In short, after simultaneously performing the liquid film forming processing and the liquid film freezing processing upon the substrate W which is held by the spin chuck 200, the processing liquid is supplied to the substrate W while the substrate W keeps rotating, thereby removing the frozen film 13f off from the front surface Wf of the substrate and hence shortening the processing time which is required for the cleaning.

### Sixth Embodiment

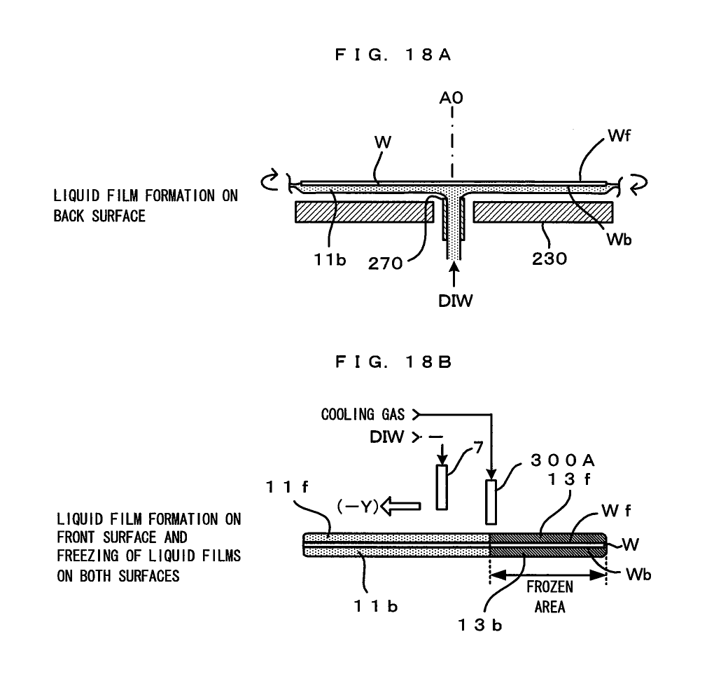

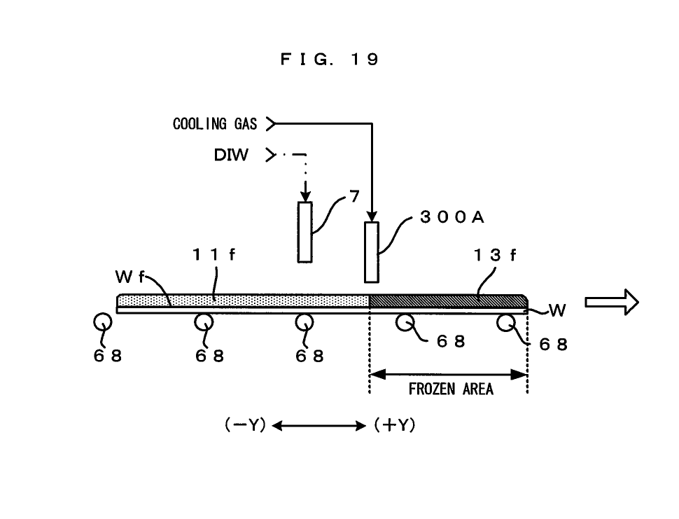

FIGS. 18A and 18B are drawings of a substrate processing apparatus according to a sixth embodiment of the invention. A major difference of the substrate processing apparatus according to the sixth embodiment from the fifth embodiment is that a frozen film (back surface side frozen film) is formed on the back surface Wb of the substrate as well, not only on the front surface Wf of the substrate. The other structure and operation are basically similar to those according to the fifth embodiment, and therefore, will be denoted at the same reference symbols but will not be described.

In the sixth embodiment, prior to formation of the liquid film on the front surface Wf of the substrate, the liquid film (back surface side liquid film) 11b is formed on the back surface Wb of the substrate (FIG. 18A). To be more specific, the spin chuck 200 holds the substrate W and the substrate W rotates about the rotation center A0. The processing liquid nozzle 270 then supplies the DIW to the back surface Wb of the substrate, the DIW spreads all over the back surface, and the back surface side liquid film 11b is formed on the back surface Wb of the substrate.

Following this, in a similar fashion to that in the fifth embodiment, the DIW discharge nozzle 7 and the cooling gas discharge nozzle 300A scan in the (−Y) direction while the DIW discharge nozzle 7 and the cooling gas discharge nozzle 300A discharge the DIW and the cooling gas, respectively. As a result, the DIW from the DIW discharge nozzle 7 forms the liquid film (front surface side liquid film) 11f on the front surface Wf of the substrate while the cooling gas from the cooling gas discharge nozzle 300A freezes the front surface side liquid film 11f. Meanwhile, the cold energy of the cooling gas supplied toward the front surface Wf of the substrate is transmitted to the back surface side liquid film 11b via the substrate W. This expands in the (−Y) direction an area where the back surface side liquid film 11b has been frozen (frozen area) inside the surface region of the back surface Wb of the substrate, while simultaneously expanding the frozen area on the front surface Wf of the substrate (FIG. 18B). In consequence, the front surface side frozen film 13f and the back surface side frozen film 13b are formed at the same time respectively on the entire front surface Wf and the entire back surface Wb of the substrate W.

As described above, as a section receiving supply of the cooling gas is limited to a local area on the front surface Wf of the substrate, it is possible to form the frozen films 13f and 13b on the front surface Wf and the back surface Wb of the substrate W while suppressing deterioration of the durability of the substrate peripheral members. Further, as the frozen films 13f and 13b are formed on the front surface Wf and the back surface Wb of the substrate W at the same time, the frozen films 13f and 13b are formed on the both surfaces of the substrate W in approximately the same period of time as that required for formation of the frozen film 13f only on the front surface Wf of the substrate.

Further, in this embodiment as well, through execution of the film removal processing upon the front surface Wf and the back surface Wb of the substrate W after freezing of the liquid films, it is possible to effectively remove particles off from the front surface Wf and the back surface Wb of the substrate W and favorably clean the both surfaces of the substrate W.

In the third through the sixth embodiments described above, supplying the liquid (DIW) to the front surface Wf of the substrate and forming the liquid film on the front surface Wf of the substrate are executed within the processing chamber 100. However, a substrate W on the front surface Wf of which a liquid film is already formed may be loaded into inside the processing chamber 100.

Further, in the third through the sixth embodiments described above, although the liquid films on the substrate W are formed with the DIW, the liquid films may be formed with other rinsing liquid. For instance, the liquid films may be formed with carbonated water, a hydrogen-saturated water, ammonium water having a diluted concentration (which may for instance be about 1 ppm), hydrochloric acid having a diluted concentration, etc. Alternatively, the liquid films may be formed with a chemical solution other than a rinsing liquid. For example, during repeated execution of the liquid film freezing step and the film removal step using a chemical solution, liquid films of the chemical solution which remain adhering to the substrate W at the film removal step are frozen at the liquid film freezing step.

Further, in the third through the sixth embodiments described above, although the operation immediately proceeds to the film removal step after freezing of the liquid films, the timing of proceeding to the film removal step may be pushed back for adjustment of the tact time. In this instance, the frozen films function as protection films although the substrate W must remain on standby in a state the frozen films are formed inside the apparatus. This prevents contamination of the front surface Wf of the substrate without fail.

Further, in the third and the fourth embodiments described above, although the cooling gas discharge nozzle 300 scans only once from the rotational center position Pc of the substrate W toward the edge position Pe of the substrate W to thereby freeze the liquid film, this is not limiting. Where the liquid film is relatively thick for instance, the cooling gas discharge nozzle 300 may scan between the rotational center position Pc of the substrate W and the edge position Pe of the substrate W over plural times in order to freeze the liquid film. However, for uniform freezing of the liquid film, the frozen area preferably expands gradually under control.

Further, in the fifth embodiment described above, the DIW discharge nozzle 7 and the cooling gas discharge nozzle 300A move while the substrate W is held still, the substrate W may be transported while the DIW discharge nozzle 7 and the cooling gas discharge nozzle 300A stay fixed. For instance, in the event that a frozen film needs be formed all over the front surface Wf of a rectangular substrate such as a glass substrate for liquid crystal display, plural transportation rollers 68 may be disposed in the direction (+Y) of a transportation direction and the DIW discharge nozzle 7 and the cooling gas discharge nozzle 300A may be fixed as shown in FIG. 19. While the substrate W is transported in the transportation direction (+Y) in this substrate processing apparatus, basic operations are exactly the same as those according to the embodiments described above, which attain similar effects. Alternatively, liquid films may be frozen while moving both the cooling gas discharge nozzle 300A and the substrate W, or liquid films may be formed while moving both the DIW discharge nozzle 7 and the substrate W.

Further, in the first and third through sixth embodiments described above, the cleaning with the SC1 solution (SC1 cleaning) as chemical cleaning which principally exerts a chemical cleaning effect upon a surface of a substrate is executed. However, the chemical cleaning performed according to the invention is not limited to the SC1 cleaning. For example, the chemical cleaning may be wet cleaning which uses, as a processing liquid, an alkaline solution, an acidic solution, an organic solvent, a surface active surfactant or the like other than the SC1 solution or wet cleaning which uses a proper combination of these as a processing liquid.

Further, in the second and third through sixth embodiments described above, the cleaning with droplets using the two-fluid nozzle (droplets cleaning) as physical cleaning which principally exerts a physical effect upon a surface of a substrate is executed. However, the physical cleaning performed according to the invention is not limited to the droplets cleaning. The physical cleaning may for example be scrub cleaning which cleans a substrate with a brush, a sponge or the like brought into contact with a surface of the substrate, ultrasonic cleaning which cleans a substrate by vibrating and separating particles adhering to a surface of the substrate utilizing ultrasonic vibrations or by means of an action upon the surface of the substrate by cavitations, air bubbles or the like formed in a processing liquid, etc.

Further alternatively, a frozen liquid film may be removed off from the surface of the substrate through cleaning of the surface of the substrate which combines depending upon necessity physical cleaning and chemical cleaning. For example, the SC1 solution may be brought into contact with the surface of the substrate, air bubbles may be formed in the SC1 solution, and the surface of the substrate may then be cleaned with the air bubbles supplied to the same. That is, combined cleaning may be performed which combines chemical cleaning which uses the SC1 solution and physical cleaning which utilizes the physical effect of air bubbles. Alternatively, a chemical solution which exerts a chemical effect upon the surface of the substrate may be used as a processing liquid during the droplets processing with the processing liquid using the two-fluid nozzle. According to this structure, combined cleaning is executed which combines chemical cleaning with the chemical solution and physical cleaning which utilizes the kinetic energy of the droplets.

Further, in the second and third through sixth embodiments described above, although the droplets cleaning using the two-fluid nozzle of the so-called external mixing type is executed, this is not limiting. A two-fluid nozzle of the so-called internal mixing type may be used to execute the droplets cleaning.

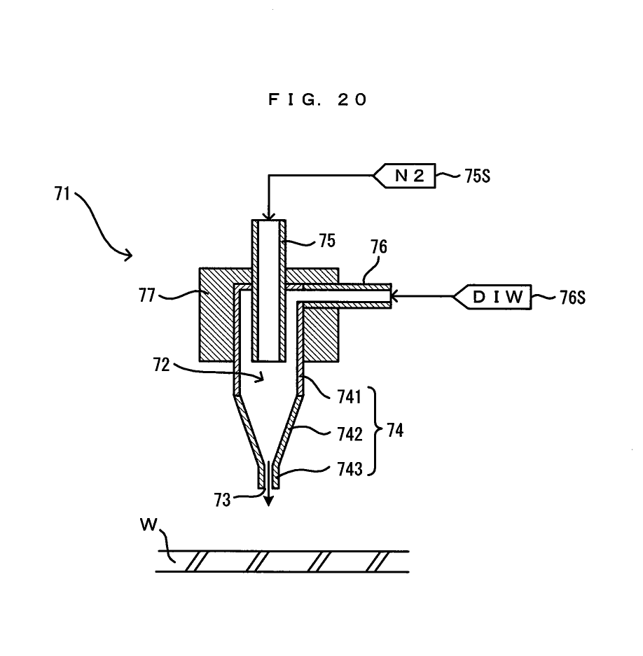

FIG. 20 is a drawing which shows a modified two-fluid nozzle. The illustrated two-fluid nozzle 71 of the internal mixing type mixes a processing liquid with gas (nitrogen gas) inside a mixing chamber 72 which is provided within the two-fluid nozzle 71 and generates droplets of the processing liquid. The nozzle 71 of the internal mixing type comprises a nozzle main body 74 which includes at its tip end an opening 73. The processing liquid is mixed with nitrogen gas inside the nozzle main body 74, thereby generating droplets of the processing liquid for cleaning, and the droplets are discharged at the opening 73 toward a substrate W. Describing this in more particular terms, the nozzle main body 74 is formed by linking a cylindrical mixing part 741, which defines the mixing chamber 72 inside of which the processing liquid and the nitrogen gas are mixed together, a tapered part 742, which is connected at its one end with the mixing part 741 and is progressively narrow toward its other end, and a straight part 743 which is a straight cylindrical tube which accelerates droplets for cleaning.

The mixing part 741 has a double pipe structure that a liquid supply pipe 76 surrounds a gas introduction pipe 75 from outside, that is, the gas introduction pipe 75 is inserted in the liquid supply pipe 76. The gas introduction pipe 75 and the liquid supply pipe 76 link respectively to a nitrogen gas supply source 75S which supplies the nitrogen gas and a DIW supply source 76S which supplies the DIW as the processing liquid. The mixing part 741 and the gas introduction pipe 75 are each shaped approximately like a circular cylinder, their central axes are aligned to each other, and the end of the gas introduction pipe 75 is housed inside the mixing part 741. Further, the mixing part 741, the gas introduction pipe 75 and the liquid supply pipe 76 are fixed to a housing 77.

Pressurized gas (nitrogen gas) is introduced into such a two-fluid nozzle 71 from the gas introduction pipe 75, and supplied with the DIW from the liquid supply pipe 76, the two-fluid nozzle 71 mixes the nitrogen gas and the DIW inside the mixing chamber 72 and generates droplets of the DIW. Moving through the tapered part 742 and the straight part 743, thus formed cleaning droplets are accelerated and discharged at the opening 73 which is formed at the tip end of the straight part 743.

Comparison of a two-fluid nozzle of the external mixing type (hereinafter referred to as an “external mixing type nozzle”) with a two-fluid nozzle of the internal mixing type (hereinafter referred to as an “internal mixing type nozzle”) identifies the following difference which is attributable to the respective nozzle structures. That is, in the case of an external mixing type nozzle, since the discharged processing liquid (DIW) and the discharged gas (nitrogen gas) are mixed together in air, the processing liquid becomes mist-like droplets and reach a substrate W as they are diffused. On the contrary, in the case of an internal mixing type nozzle, since droplets of a processing liquid formed inside the nozzle are accelerated up to a predetermined speed, and thus formed droplets of the processing liquid move straight ahead toward and arrive at a substrate W as they maintain their speed not much attenuated. Due to this, an internal mixing type nozzle cleans with droplets having such particle diameters which fall within a relatively large particle diameter range, and hence, is characterized in that it more greatly damages a substrate W in return for its greater cleaning power (particle removal rate) as compared with an external mixing type nozzle. Meanwhile, an external mixing type nozzle cleans with droplets having similar and relatively small particle diameters and is characterized in that it damages a substrate W far less greatly despite its weaker cleaning power as compared with an internal mixing type nozzle. According to the invention therefore which makes it possible to weaken the adherence of particles to a surface of a substrate or separate the particles from the surface of the substrate by means of freezing of a liquid film, use of an external mixing type nozzle improves the removal rate while avoiding damage upon a substrate W without fail.

Further, in the embodiments described above, although the liquid film is formed by draining the surface of the substrate off of the DIW supplied to the same, the liquid film may be formed without draining the surface of the substrate off of the DIW.

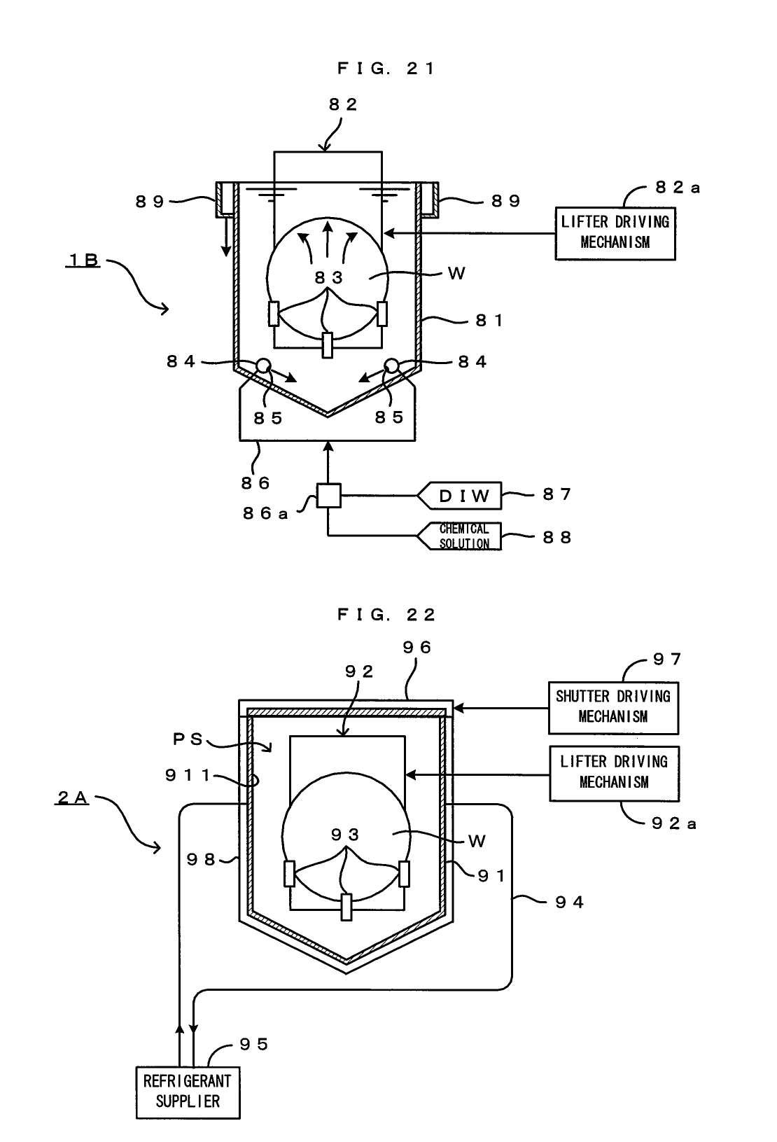

While the embodiments described above are directed to a single-wafer type substrate processing apparatus which cleans substrate W one by one, the invention is applicable also to a batch type substrate processing apparatus which cleans plural substrates W all at once. For instance, the structure as that shown in FIG. 21 may be used for a batch type cleaning unit which forms liquid films and removes frozen liquid films.

FIG. 21 is a diagram showing a construction of a modification of a cleaning unit equipped in the substrate processing apparatus according to the invention. This cleaning unit 1B includes a processing tank 81 which stores a processing liquid such as chemical solution and DIW. Substrates W such as semiconductor wafers are loaded into the processing tank 81 to be accommodated therein, and subjected to the liquid film formation and the removal of the liquid film which has been processed freezing with the processing liquid in the processing tank 81. A lifter 82 which accommodates a plurality of substrates W in upright posture is disposed in the processing tank 81. This lifter 82 is free to move upward and downward between an inner position (position shown in FIG. 21) in the processing tank 81 and an upper position above the processing tank 81, and is driven to elevate by a lifter driving mechanism 82a which functions as an “immersing section” of the present invention. The lifter 82 includes three substrate holding guides 83 which hold a plurality of substrates W. A plurality of notch-shaped holding grooves engageable with parts of peripheral edge portions of the substrates W are formed to hold the substrates W in the three substrate holding guides 83 while being arranged at specified intervals in a longitudinal direction (direction normal to the surfaces of the substrates W).

Two tubular processing liquid supply nozzles 84 are arranged substantially in a horizontal direction near the inner bottom of the processing tank 81. A plurality of discharge holes 85 for discharging the processing liquid are formed in each processing liquid supply nozzle 84. Further, the respective processing liquid supply nozzles 84 are connected to processing liquid supply pipes 86 and the respective processing liquid supply pipes 86 are connected to a DIW supplier 87 and a chemical solution supplier 88 via a mixing unit 86a. Therefore, the processing liquid (DIW or chemical solution) is supplied from the respective processing liquid supply nozzles 84 to the processing tank 81 via the mixing unit 86a. The processing liquid discharged from the respective processing liquid supply nozzles 84 at both left and right sides overflows through an opening at the top of the tank while forming an upward flow in the middle of the tank. Then, particles dispersed in the processing liquid are collected together with the overflowed processing liquid into an overflow tank 89 and discharged to the outside of the tank. Thus, according to this modification, the processing liquid supply nozzles 84 function as an “introducer” of the invention.

Thus constructed, in the case where DIW is stored in the processing tank 81, liquid film can be formed on the substrate surface as follows. That is, when the lifter driving mechanism 82a is driven for downward movement in accordance with an operation command from the control unit 4, the lifter 82 accommodating a plurality of substrates W is moved downward from the upper position. Thus, a plurality of substrates W are simultaneously immersed into the DIW stored in the processing tank 81. When the lifter driving mechanism 12a is driven for upward movement and the lifter 82 is moved upward thereafter, a plurality of substrates W are pulled up from the DIW stored in the processing tank 81. In this way, the DIW adheres to the respective surfaces of a plurality of substrates W, whereby liquid films (water films) can be collectively formed on the surfaces of these substrates W.

Further, in the case where SC1 solution is stored in the processing tank 81, frozen film can be removed from the substrate surface as follows. That is, the lifter driving mechanism 82a is driven to move the lifter 82 downward. Thus, a plurality of substrates W after the freezing are simultaneously immersed into the SC1 solution stored in the processing tank 81. As a result, the frozen film on the substrate surface is defrosted by the SC1 solution and the frozen film containing particles are removed from the substrate surface by the convection flow of the SC1 solution in the processing tank 81. Meanwhile, in the case where the particle removal performance is not enough simply by immersing the substrates W which has been processed freezing in the SC1 solution, it may be constructed such that bubbles are generated in the processing liquid by bubbling a nitrogen gas in the processing liquid for instance, and the bubbles are supplied toward the substrate surface.

Further, the construction shown in FIG. 22 may be adopted as a batch processing freezing unit which freezes the liquid film. FIG. 22 is a diagram showing a modification of a construction of a freezing unit equipped in the substrate processing apparatus according to the invention. The freezing unit 2A includes a processing tank 91 in which a processing space PS capable of accommodating a plurality of substrates W is formed. A lifter 92 is so disposed in the freezing unit 2A as to be movable upward and downward between an inner position (position shown in FIG. 22) in the processing tank 91 and an upper position above the processing tank 91, and is driven to elevate by a lifter driving mechanism 92a. Thus, a plurality of substrates W can be placed at the upper position above the processing tank 91 and the position accommodated in the processing space PS while being held by substrate holding guides 93 which the lifter 92 has.

An inner wall surface 911 of the processing tank 91 is a cooling surface which cools the processing space PS, and a refrigerant path 94 is formed along the inner wall surface 911 so as to surround the processing space PS. The opposite ends of this refrigerant path 94 are connected to a refrigerant supplier 95. The refrigerant supplier 95 includes a cooler which cools the refrigerant and a pumping unit such as a pump which pressure-feeds the refrigerant to the refrigerant path 94 to circulate it in the refrigerant path 94. Thus, the refrigerant is supplied from the refrigerant supplier 95, and the one having come out of the refrigerant path 94 returns to the refrigerant supplier 95 again. It should be noted that any refrigerant may be used provided that it can cool the temperature of the processing space PS below the freezing point of the processing liquid via the inner wall surface 911.

The top of the processing tank 91 serves as a substrate entrance and can be opened and closed by driving a shutter 96 by a shutter driving mechanism 97. The substrates W can be loaded and unloaded through an opening by the lifter driving mechanism 92a with the top of the processing tank 91 opened, whereas the processing space PS in the processing tank 91 can become a sealed space with the top of the processing tank 91 closed. Further, the outer wall of the processing tank 91 and the shutter 96 are covered by a heat insulating material 98 in order to improve the cooling efficiency of the processing space PS in the sealed state.

According to the construction described above, the temperature of the entire processing space PS in the processing tank 91 is cooled below the freezing point of the liquid (DIW) which composes the liquid film. Then, the shutter 96 is opened and the lifter 92 is moved downward by the lifter driving mechanism 92a and accordingly the substrates W are positioned at a position accommodated in the processing space PS in the processing tank 91. The shutter 96 is closed thereafter and the liquid films adhering to the respective surfaces of the plurality of the substrates W are simultaneously frozen. Thus, the liquid films adhering to the respective surfaces of the plurality of the substrates W can be collectively frozen and hence, it is possible to enhance the processing efficiency.

The present invention is applicable to a substrate processing apparatus and a substrate processing method for cleaning substrates in general including semiconductor wafers, glass substrates for photomasks, glass substrates for liquid crystal displays, glass substrates for plasma displays and substrates for optical discs.

Although the invention has been described with reference to specific embodiments, this description is not meant to be construed in a limiting sense. Various modifications of the disclosed embodiment, as well as other embodiments of the present invention, will become apparent to persons skilled in the art upon reference to the description of the invention. It is therefore contemplated that the appended claims will cover any such modifications or embodiments as fall within the true scope of the invention.

What is claimed is:

1. A substrate processing method of cleaning a substrate, the method comprising:
a first step of freezing a liquid film as it is maintained adhering to a surface of the substrate; and
a second step of performing upon the surface of the substrate physical cleaning which exerts a physical effect upon the surface of the substrate, chemical cleaning which exerts a chemical effect upon the surface of the substrate, or cleaning which combines the physical cleaning and the chemical cleaning, thereby removing the liquid film which has been processed freezing off from the surface of the substrate.

2. The substrate processing method of claim 1, wherein at the second step, the liquid film is removed off from the surface of the substrate before the liquid film which has been processed freezing is melted.

3. The substrate processing method of claim 1, wherein at the second step, the liquid film which has been processed freezing is removed off from the surface of the substrate by supplying an SC1 solution toward the surface of the substrate, the SC1 solution being a liquid mixture of aqueous ammonia and a hydrogen peroxide solution.

4. The substrate processing method of claim 1, wherein at the second step, the liquid film which has been processed freezing is removed off from the surface of the substrate by supplying droplets of a processing liquid toward the surface of the substrate, the droplets being generated by mixing the processing liquid with gas.

5. A substrate processing apparatus for cleaning a substrate, the apparatus comprising:
a freezing mechanism which freezes a liquid film as it is maintained adhering to a surface of the substrate; and
a cleaning mechanism which performs, upon the surface of the substrate, physical cleaning which exerts a physical effect upon the surface of the substrate, chemical cleaning which exerts a chemical effect upon the surface of the substrate, or cleaning which combines the physical cleaning and the chemical cleaning, wherein
the freezing mechanism freezes the liquid film adhering to the surface of the substrate as preprocessing prior to cleaning by the cleaning mechanism, and
the cleaning mechanism performs upon the surface of the substrate the physical cleaning, the chemical cleaning or the cleaning which combines the physical cleaning and the chemical cleaning, thereby removing the liquid film which has been processed freezing off from the surface of the substrate.

6. The substrate processing apparatus of claim 5, wherein the cleaning mechanism includes a supplier which supplies an SC1 solution toward the surface of the substrate and a rotator which rotates the substrate, the SC1 solution being a liquid mixture of aqueous ammonia and a hydrogen peroxide solution, and
the SC1 solution is supplied from the supplier to the surface of the substrate which is rotated by the rotator.

7. The substrate processing apparatus of claim 5, wherein the cleaning mechanism includes a processing tank which holds an SC1 solution, the SC1 solution being a liquid mixture of aqueous ammonia and a hydrogen peroxide solution, an introducer which introduces the SC1 solution into the processing tank and makes the SC1 solution flow over from the processing tank, and an immersing section which immerses the substrate into the SC1 solution which is held within the processing tank, and
the immersing section immerses, together with the substrate, the liquid film which has been processed freezing into the SC1 solution which is held within the processing tank.

8. The substrate processing apparatus of claim 5, wherein the cleaning mechanism includes a two-fluid nozzle, which is capable of discharging droplets of a processing liquid which are generated by mixing the processing liquid with gas toward the surface of the substrate, a processing liquid supply source which supplies the processing liquid to the two-fluid nozzle, and a gas supply source which supplies the gas to the two-fluid nozzle.

9. The substrate processing apparatus of claim 8, wherein the two-fluid nozzle includes a processing liquid discharger which discharges the processing liquid and a gas discharger which is disposed in the vicinity of the processing liquid discharger and discharges the gas, and
the two-fluid nozzle generates the droplets of the processing liquid by mixing the processing liquid discharged from the processing liquid discharger with the gas discharged from the gas discharger in air, and makes the generated droplets collide with the surface of the substrate.
